(19) United States
(12) Patent Application Publication
(10) Pub. No.: US 2012/0221198 A1
(43) Pub. Date: Aug. 30, 2012

(54) WATER GENERATION UNIT AND SYSTEM AND METHOD OF WATER SUPPLY PRODUCTION AND MANAGEMENT IN VEHICLES

(75) Inventors: Arye Kohavi, Neve Monosson (IL); Avi Peretz, Neve Monosson (IL); Eliahu Maier, Petach-Tikva (IL)

(73) Assignee: WATER-GEN LTD., Neve Monosson (IL)

(21) Appl. No.: 13/391,190

(22) PCT Filed: Aug. 30, 2010
(86) PCT No.: PCT/IL10/00711

§ 371 Date: May 8, 2012

(30) Foreign Application Priority Data
Sep. 1, 2009 (IL) 200680

(51) Int. Cl. B60H 1/32; F25D 31/00

(52) U.S. Cl. 701/36; 62/318

(57) ABSTRACT

A system of managing water production in a vehicle. The system comprises a water conducting element set to receive and conduct water generated as a product of an operation of a vehicle air conditioner of the vehicle to a water container, a gauge that measures the amount of water in the water container, and a manager that receives the measurement and instructs the operation accordingly.

### RELATED APPLICATION

This application claims priority from Israel Patent Application No. 200680, filed on Sep. 1, 2009 and from U.S. patent application Ser. No. 12/686,405 filed 13 Jan. 2010. The contents of these applications are incorporated by reference as if fully set forth herein.

### FIELD AND BACKGROUND OF THE INVENTION

The present invention, in some embodiments thereof, relates to method and device of producing and managing water supply and, more particularly, but not exclusively, to method and device of producing and managing water supply in vehicles.

The availability of fresh, purified drinking water is highly desirable in virtually every environment and circumstance. For example, individuals in homes and offices often install complex and expensive filtration systems, or buy small individual bottles of spring water for personal consumption purposes. Many machines also employ various types of water and air filtration systems to create water that is safe to drink.

For example U.S. Pat. No. 6,237,352 filed on May 29, 2001 describes a machine capable of generating and dispensing potable water. The features of the machine include continuous water filtration, a durable primary outer housing unit designed to minimize damage during transportation and handling, and a hot gas injection system designed to allow the generation of water from ambient air at temperatures as low as 50° F. Another example is found in U.S. Patent Application No. 2007/101862 filed on Nov. 7, 2005 that describes a water production unit that uses liquid desiccant and vehicle exhaust for extracting water from air.

Another example is found in U.S. Pat. No. 7,043,934, filed on Feb. 4, 2004 describes a water making device that collects the moisture contained in the atmosphere and condenses it into high purity water. In one embodiment, ambient air entering the water making water cooling system flows across an air filter, then a precooler heat exchanger (where the air stream is cooled to or close to its dew point) and then a water extraction heat exchanger, where the air stream is cooled further and water is extracted. The water that leaves water extraction heat exchanger is collected in a water collection device and passes from there through a primary water filter into a water storage tank. The air stream then passes across a reheat heat exchanger and exhausted to the outside. A water circulation pump extracts water from the water storage tank and circulates the water stream through an evaporator of a vapor compression refrigeration system, where the water stream is chilled, then through the water extraction heat exchanger and precooler, where the incoming air stream is chilled by removing heat to the water stream. The water stream is then circulated through the reheat heat exchanger, where the water stream is again cooled by removing heat to the cool dry air exiting the water extraction heat exchanger. Finally, the cooled water stream is circulated through the water filter to a three way valve, which directs water flow either to a dispenser or back to the water storage tank.

There is a number of portable water generating machines which may be used outdoors. These portable water generating machines employ conventional dehumidifiers for removing water from the air for collection into a storage tank. For example U.S. Patent Application No. 2007/101862 filed on Nov. 7, 2005 that describes a water production unit that uses liquid desiccant and vehicle exhaust for extracting water from air.

Another example is the Recovery Unit from Exhaust (WRUE) generator that generates water by capturing water from fuel expended by engines on the battlefield. To recover potable water from engine emissions, water is condensed from exhaust gas and then purified using a three-stage filtration process. The portion of the exhaust that is unused leaves the vehicle through an exhaust port, while the condensed exhaust is collected in the water receiver. A water pump then sends the exhaust condensate from the water receiver to the water purification subsystem. The water now waits to be purified through the use of three separate filters; a particle, activated carbon and ion exchange resin. To help monitor the life of the filters, sensors are mounted inside the crew compartment of the vehicle to let Soldiers when the system is in use, and it also allows Soldiers to turn it off when it is not needed, see www.rdecom.army.mil/rdemagazine/200506/itl_operationH2O.html.

### SUMMARY OF THE INVENTION

According to some embodiments of the present invention there is provided a system of managing water production in a vehicle. The system comprises water conducting element set to receive and conduct water generated as a product of an operation of a vehicle air conditioner of the vehicle to a water container, a gauge that measures the amount of water in the water container, and a manager that receives the measurement and instructs the operation accordingly.

Optionally, the system further comprises a water treatment unit set to receive and treat the water.

Optionally, the system further comprises at least one sensor for measuring at least one of a temperature and a humidity level in a passenger compartment of the vehicle or outside the vehicle, the vehicle air conditioner manager instructs the operation according to at least one of the temperature and the humidity.

More optionally, the vehicle air conditioner manager instructs the changing of an air flow to the vehicle air conditioner according to the at least one of the temperature and the humidity.

More optionally, the vehicle air conditioner manager instructs the changing of at least one of cooling output and heating output of the vehicle air conditioner according to the at least one of the temperature and the humidity.

Optionally, the vehicle air conditioner manager instructs the operation according to at least one of an estimated water shortage evaluation and an estimated water consumption evaluation.

Optionally, the vehicle air conditioner manager controls an air valve that either diverts air flow from the vehicle air conditioner toward either a passenger compartment of the vehicle or diverts the air flow to another space or block the air flow.

Optionally, the vehicle air conditioner manager controls the blower of the vehicle air conditioner so as to change the air supply thereof.

Optionally, the vehicle air conditioner manager instructs the operation by forwarding instructions to a controller of the vehicle air conditioner.

Optionally, the vehicle air conditioner manager instructs the operation by forwarding instructions to the vehicle air conditioner directly.

Optionally, the instructions comprise instructions of changing the incoming air flow mode of the vehicle air conditioner.

Optionally, the system further comprises an additional evaporator connected to a cooling gas tubing of the vehicle air conditioner, the instructions comprises instructions of activating the additional evaporator in addition or instead of an evaporator of the vehicle air conditioner.

Optionally, the system further comprises a man machine interface (MMI) for allowing an operator to select among at least two modes of a group consisting of a cooling mode, warning mode, a water generation mode, and a combined mode of to cooling or warming and improved water generation.

More optionally, the water treatment unit set to perform at least one of enriching the water and filtering the water.

More optionally, the water treatment unit set to receive and treat water generated by at least one water generation unit installed on the vehicle, the manager instructs a water generation operation of the at least one water generation unit according to the operation.

More optionally, the system further comprises an external radiator for producing water when the vehicle air conditioner being in a heating mode and a water tray for conducting water therefrom to the water treatment unit.

According to some embodiments of the present invention there is provided an apparatus of diverting air flow of an air conditioner in a vehicle. The apparatus comprises an air valve that diverts air flow from a vehicle air conditioner of a vehicle toward either a passenger compartment of the vehicle or a separated space, a sensor that detects a temperature in the passenger compartment, and a manager that controls the air valve during an operation of the vehicle air conditioner, according to the temperature.

Optionally, the manager controls the air valve to block at least partly the air flow during the operation.

Optionally, the manager controls the air valve according to a member of a group consisting of: estimated water consumption, estimated water shortage, an amount of water generated by the vehicle air conditioner and an amount of water in a water container that stores water generated by the vehicle air conditioner.

According to some embodiments of the present invention there is provided a method of diverting air flow of an air conditioner in a vehicle. The method comprises providing an air valve that diverts air flow from a vehicle air conditioner of a vehicle toward either a passenger compartment of the vehicle or a separated space, detecting at least one of a temperature in the passenger compartment and a desired temperature in the passenger compartment, and adjusting the air valve to divert the air flow toward either the passenger compartment or the separated space according to at least one of the temperature and the desired temperature.

Optionally, the diverting allows utilizing the vehicle air conditioner for water generation without undesirably changing the temperature in the passenger compartment.

According to some embodiments of the present invention there is provided a device of managing one or more water generation units in a vehicle. The device comprises at least one water generation unit that extracts water vapors from an ambient air to provide a first amount of water, a water treatment unit set to receive and treat the first amount of water and a second amount of water from a water outlet of a vehicle air conditioner, a water conducting element for conducting the treated water to a water container, and a manager which instructs an operation of the at least one water generation unit according to at least one of an amount of water in the water container and a current operation of the vehicle air conditioner.

According to some embodiments of the present invention there is provided a method of controlling a vehicle air conditioner. The method comprises accumulating water generated as a product of an operation of a vehicle air conditioner, measuring an amount of the accumulated water, computing an adjustment to the operation, and instructing the vehicle air conditioner to operate according to the adjustment.

Optionally, the measuring further comprises measuring at least one of a temperature, an air flow, an evaporation temperature, and a humidity level in a passenger compartment or outside the vehicle and instructing the vehicle air conditioner to operate according to at least one of the temperature, the air flow, the evaporation temperature, and the humidity.

According to some embodiments of the present invention there is provided a method of managing water supply. The method comprises accumulating water generated as a product of a vehicle air conditioner, detecting at least one of an amount of the accumulated water and a current operation mode of the vehicle air conditioner, operating a water generation unit according to at least one of the amount and the current operation mode, and accumulating water generated by the water generation unit.

Optionally, the operating is performed according to the amount of power required for the performance thereof.

According to some embodiments of the present invention there is provided a vehicle integrable device of water production, comprising at least one air drawing unit for drawing moist air via an air inlet, a filtering unit for filtering the moist air, a dehumidifying unit for condensing water vapor from the moist air and having a water outlet for extracting the condensed water vapor, and an air outlet for extracting the filtered air, a water container for accumulating the condensed water vapor, and a housing configured for being mounted directly on an armored fighting vehicle (AFV) and containing the at least one air drawing unit, the filtering unit, and the dehumidifying unit.

Optionally, the vehicle integrable device further comprises a power plug configured for facilitating the powering of the dehumidifying unit from the power source of the AFV.

Optionally, the vehicle integrable device further comprises an alternator for supplying DC voltage for operating the refrigerant compressor or blowers, connected to the crankshaft of the engine of the AFV for facilitating the powering of the dehumidifying unit.

Optionally, the dehumidifying unit further comprises a refrigerant air compressor, wherein the refrigerant compressor is powered by an air compressor of the AFV.

Optionally, the air drawing unit having is powered by an air compressor of the AFV.

Optionally, the vehicle integrable device further comprises a water inlet for receiving a water stream from the cooling system of the AFV.

Optionally, the dehumidifying unit having desiccant wheel and a cold coil evaporator, the desiccant wheel carrying the water vapor toward the evaporator so as to allow the condensing thereof.

Optionally, the filtering unit comprises a canister housing sized and shaped for supporting at least one cylindrical filter, the at least one cylindrical filter being placed to filter the moist air.

Optionally, the filtering unit having a chamber for containing modularly any combination of a plurality of filters.

Optionally, the filtering unit is configured to support a micro fiber filter, an activated carbon filter, and a charcoal dust filter so as to allow each the filter to filter the moist air.

Optionally, the vehicle integrable device further comprises a water filtering unit for filtering the water.

More optionally, the water filtering unit comprises an ultraviolet (UV) lamp for illuminate the water.

More optionally, the water cleaning unit is configured for periodically, sequentially or randomly cycling the water via the water filtering unit.

More optionally, the water cleaning unit is configured for performing the filtering by passing the condensed water vapor via at least one membrane so as to allow a reverse osmosis (RO).

Optionally, the vehicle integrable device further comprises a controller for controlling at least one of the dehumidifying unit, a vehicle unit of the AFV, an air valve, a water valve, an air blower, and a water pump according to the output of at least one sensor.

Optionally, the at least one sensor comprising a member of a group consisting of a sensor monitoring power generated by a vehicle unit of the AFV and, a sensor monitoring air pressure in at least one of the vehicle unit.

More optionally, the at least one sensor comprises a water sensor for estimating the amount of the condensed water vapor in the water container and outputting a notification accordingly.

More optionally, the at least one sensor comprises a humidity sensor for outputting a humidity level.

More optionally, the at least one sensor comprises a volt meter outputting an available electric power estimation.

More optionally, the at least one sensor comprises a temperature sensor for outputting a current temperature.

More optionally, the air inlet is placed to draw air from a first space, the at least one air drawing unit being configured for drawing the moist air from a second space via an additional air inlet, the controller being configured to instruct the at least one pump so at to draw the moist air via at least one of the air inlet the additional air inlet.

More optionally, the controller is configured to manage the operation of the dehumidifying unit according to a predefined set of rules.

Optionally, the air inlet is placed to draw air from a passenger comportment of the vehicle.

Optionally, the filtering unit comprises a cyclonic filter for separating sand or dirt from the moist air.

Optionally, the vehicle integrable device further comprises at least one shock absorber connected to at least one of the filtering unit, the dehumidifying unit and the at least one air drawing unit and configured from absorbing shocks in between them and the vehicle.

Optionally, the housing is at least one of CBRN (NBC) sealed, hardened, and heat isolated.

Optionally, the vehicle integrable device further comprises a cleaning unit configured for drawing at least a portion of the condensed water vapor and passing the condensed water vapor via at least one element of the dehumidifying unit.

Optionally, the cleaning unit being configured for cleaning water generated by a cooling system of the AFV.

More optionally, the cleaning unit comprises at least one valve for directing the portion away from the vehicle integrable device.

Optionally, the vehicle integrable device further comprises an enriching unit for adding at least one enriching material to the condensed water vapor.

More optionally, the at least one enriching material convert the water to at least one of isotonic water, sports water, and energy water.

Optionally, the housing is configured to be detachably coupled to the AFV.

Optionally, the housing having a handle and wheels so as to allow a user to pull the vehicle integrable device using one hand.

Optionally, the water container is detachable.

Optionally, the water container having an adjustable dimension, the dimension being adjusted according to an amount of the water.

Optionally, the filtering unit comprises a nuclear, biological, chemical CBRN (NBC) filter and having a CBRN (NBC) sealing.

According to some embodiments of the present invention there is provided a method of water production. The method comprises a) integrating a dehumidifying unit in an armored fighting vehicle (AFV), b) drawing a moist air from at least one of the surrounding of and a passenger compartment of the AFV, c) filtering the drawn moist air dehumidifying unit, d) using the dehumidifying unit for condensing water vapor from the moist air, and e) accumulating the condensed water vapor.

Optionally, the integrating comprises at least one member of a group consisting of connecting a vehicle's power source to the dehumidifying unit, using a vehicle's ventilation system for performing the drawing, using at least one vehicle's filter for filtering the moist air from, and drawing the moist air from the passenger comportment.

Optionally, further comprises filtering the condensed water vapor.

Optionally, further comprises sensing a humidity level in at least one of the surrounding of and the passenger compartment of the AFV and initiating the drawing accordingly.

Optionally, further comprises accumulating water from an external source and performing the b)-e) according to the amount of the water.

Optionally, further comprises using the condensed water for cleaning a filter performing the filtering.

Optionally, further comprises enriching the condensed water vapor. According to some embodiments of the present invention there is provided a vehicle integrable device of water production. The vehicle comprises a filtering unit for filtering ambient moist air, a dehumidifying unit for condensing water vapor from the ambient moist air and having a water outlet for extracting the condensed water vapor, and an air outlet for extracting the filtered air, a water container for accumulating the condensed water vapor, and a reverse osmosis filter for filtering the accumulated water vapor.

Optionally, further comprises a waste drain for extracting a plurality of particles filtered from the accumulated water vapor.

According to some embodiments of the present invention there is provided an armored fighting vehicle (AFV) having a device of water production. The AFV comprises a water production unit for condensing water vapor from at least one of ambient moist air and moist air from the passenger compartment of the AFV. The water production unit is powered by a power source of the AFV.

Optionally, the power source is selected from a group consisting of a battery of the AFV and a crankshaft of the engine of the AFV.

Optionally, the water production unit uses at least one of a compressor and a dehumidifier element of a cooling system of the AFV.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a device of managing the supply of water generated as a product of an operation of a vehicle air conditioner, according to some embodiments of the present invention;

FIG. 2A is a flowchart of a method of operating a vehicle air conditioner according to water consumption and/or shortage, water generation status, and/or water resources, according to some embodiments of the present invention;

FIG. 2B is a flowchart of a method for instructing the operation of the air conditioner according to a required cooling level in the passenger compartment, according to some embodiments of the present invention.

FIG. 2C is another flowchart of a method of operating a vehicle air conditioner as shown at FIG. 2A where the method further includes operations performed when the vehicle air conditioner in not used for cooling and/or heating the passenger compartment, according to some embodiments of the present invention;

FIG. 3A is a schematic illustration of a water treatment unit with a water filtering unit of reverse osmosis filtering, according to some embodiment's of the present invention;

FIG. 3B is a schematic illustration of the components of an exemplary water treatment unit, according to some embodiments of the present invention;

FIG. 3C is A Schematic Illustration of a means of pumping water from a tray or a container inclined in relation to the horizon, according to some embodiments of the present invention;

FIG. 4 is a schematic illustration of an enrichment unit designed to be connected to the water outlet, according to some embodiments of the present invention;

FIG. 5 a schematic illustration of a device of managing an operation of an air valve directing air from the vehicle air conditioner, according to some embodiments of the present invention;

FIG. 6 is a schematic illustration of a device of managing an operation of a vehicle air conditioner and one or more additional water sources, such as water generation units, according to some embodiments of the present invention

FIG. 7 is an exemplary arrangement in which two radiators are interchangeably used condensers and/or evaporators, according to some embodiments of the present embodiment;

FIG. 8 is a schematic illustration of a vehicle integrable device for producing water from air, according to some embodiments of the present invention;

FIG. 9A is a schematic illustration of an exemplary dehumidifying unit having a desiccant wheel, according to some embodiments of the present invention;

FIGS. 9B-9G are schematic illustrations of exemplary pre cooling arrangement for cooling humid air before it is passed in front of the evaporator of the water generation unit, according to some embodiments of the present invention;

FIG. 10 is a sectional schematic illustration of the vehicle integrable device with a high efficiency particulate air (HEPA) filtering unit, according to some embodiments of the present invention;

FIG. 11A is a sectional schematic illustration of the vehicle integrable device with a canister based filtering unit, according to some embodiments of the present invention;

FIG. 11B is a sectional schematic illustration of the vehicle integrable device with another canister based filtering unit, according to some embodiments of the present invention;

FIG. 12A is a rear sectional schematic illustration of the vehicle integrable device with a water filtering unit of reverse osmosis filtering, according to some embodiments of the present invention;

FIG. 12B is a schematic illustration of elements used for creating a water circle cleaning water, such as the accumulated water and/or water from additional sources, and an exemplary arrangement of the elements, according to some embodiments of the present invention;

FIG. 12C is a vehicle integrable device that combines both an air filtering system and a water filtering system and uses a cooling system that comprises a refrigerant compressor, according to some embodiments of the present invention;

FIG. 13 is a sectional schematic illustration of the vehicle integrable device with a cyclonic filtering unit for separating unwanted debris from an air, according to some embodiments of the present invention;

FIG. 14 is a flowchart of a method of producing water from air using a vehicle integrable device, according to some embodiments of the present invention;

FIG. 15 is a schematic illustration of the components of a self cleaning unit that is used for cleaning one or more of an evaporator, a condenser and/or other relate parts, according to some embodiments of the present invention;

FIG. 16 is a schematic illustration of a vehicle integrable device which is set up in a cart, according to some embodiments of the present invention; and

FIG. 17 is a schematic illustration of a foldable water container, according to some embodiments of the present invention; and

FIG. 18 is a method of controlling one or more water generation units according to water output and/or operation of a vehicle air conditioner, according to some embodiments of the present invention.

### DESCRIPTION OF EMBODIMENTS OF THE INVENTION

The present invention, in some embodiments thereof, relates to method and device of producing and managing water supply and, more particularly, but not exclusively, to method and device of producing and managing water supply in vehicles. As used herein a vehicle means a car, a track, a train, a boat, an airplane, an armored vehicle, such as an armored combat vehicle, for example a tank and/or other armored fighting vehicle (AFV), military SUV and the like.

According to an aspect of some embodiments of the present invention there is provided system and method of producing and managing an air conditioner of a vehicle, according to water reservoir and/or water demand and/or supply. The system includes a water conducting element set to receive and conduct water generated as a product of the vehicle air conditioner to a water container. Optionally, the system includes a water treatment unit for treating the water. The system further comprises a gauge that measures the amount of water in the water container and/or one or more sensors having measurements indicative of water consumption, water generation status, weather conditions, electricity power available and/or available water resources. The system further comprises a manager that receives one or more of these measurements and instructs an operation of the vehicle air conditioner accordingly. Optionally, the manager computes instructions according to the measurements, for example current weather conditions (temperature, humidity etc.) and estimated water shortage and forwards the instructions to the controller of the vehicle air conditioner.

According to an aspect of some embodiments of the present invention there is provided device and method of diverting an air flow of an air conditioner so that an vehicle air conditioner may be used for producing water without undesirably changing the temperature in the passenger compartment. The device includes an air valve that diverts air flow from an air conditioner of a vehicle either toward a passenger compartment of the vehicle or to another space, for example a cooling and/or a heating system, another compartment, and/or outside the vehicle. Optionally, the air valve diverts the air flow toward a system that transfers air to cool suits of the passengers. The device includes a sensor that detects a temperature in the passenger compartment and a manager that controls the air valve during an operation of the vehicle air conditioner, according to the temperature. For example, if the operator set the desired temperature in the vehicle air conditioner to a certain temperature and the vehicle air conditioner starts to reduce or to increase the temperature below the certain temperature, the manager instructs the air valve to direct at least some of the air generated by the vehicle air conditioner to the separated space. In such a manner, the vehicle air conditioner can still be operated to produce water without over cooling and/or overheating the passenger compartment.

According to an aspect of some embodiments of the present invention there is provide device and method of managing a water production of water generation units according to the activity of a vehicle air conditioner. The device includes and/or controls one or more water generation unit that extracts water vapors from an ambient air to provide a first amount of water and a water treatment unit set to receive and treat this first amount of water and a second amount of water from a water outlet of the vehicle air conditioner. The device includes an outlet for conducting the treated water from the treating unit to a water container. The device further includes a manager that instructs an operation of the one or more water generation units according to an amount of water in the water container and/or the operation mode of the vehicle air conditioner.

According to an aspect of some embodiments of the present invention there is provided a device and a method of managing the vehicle air conditioner in an operation mode adjusted for low temperature, for example a temperature of less than 15° In such an operation mode the cooled air is diverted from the passenger compartment to another space, for example to the external space in which the vehicle is found and/or usage, the cooling output and evaporating temperature is reduced, and/or only part of the condenser or the evaporator is used. Such operations will reduce the evaporating temperature and allows using a vehicle air conditioner not designated to work in a cooling mode when the temperature is less than 15° for producing water.

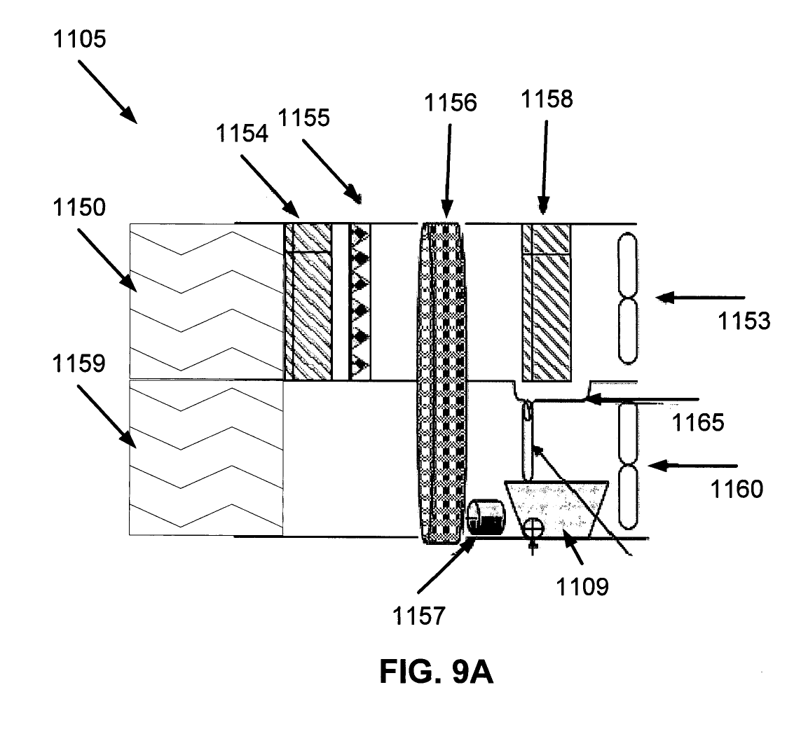

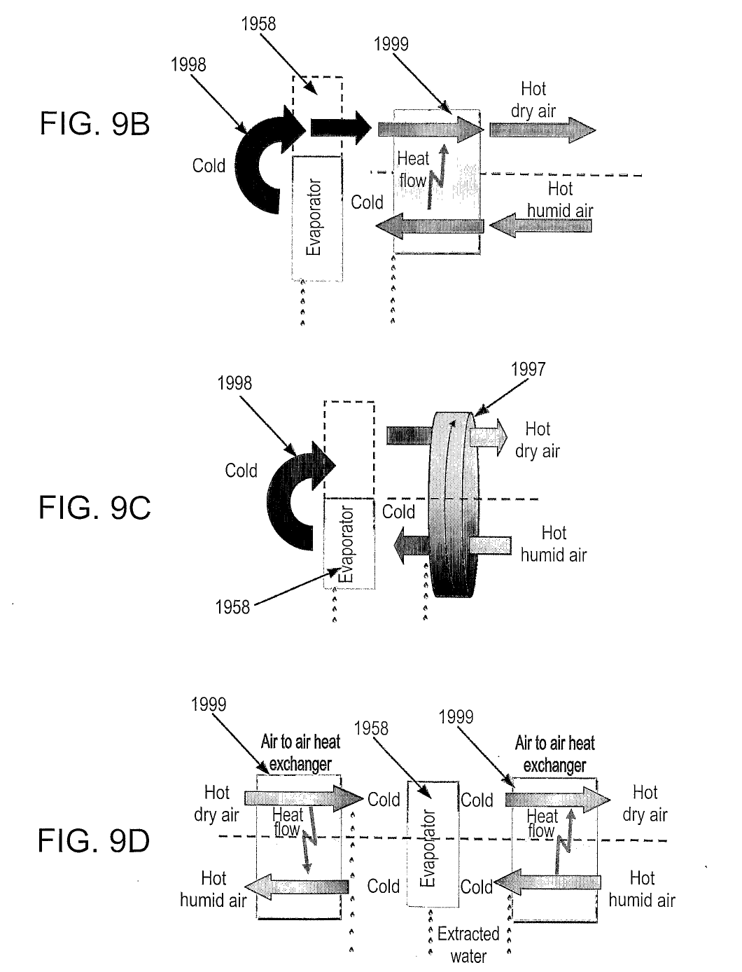

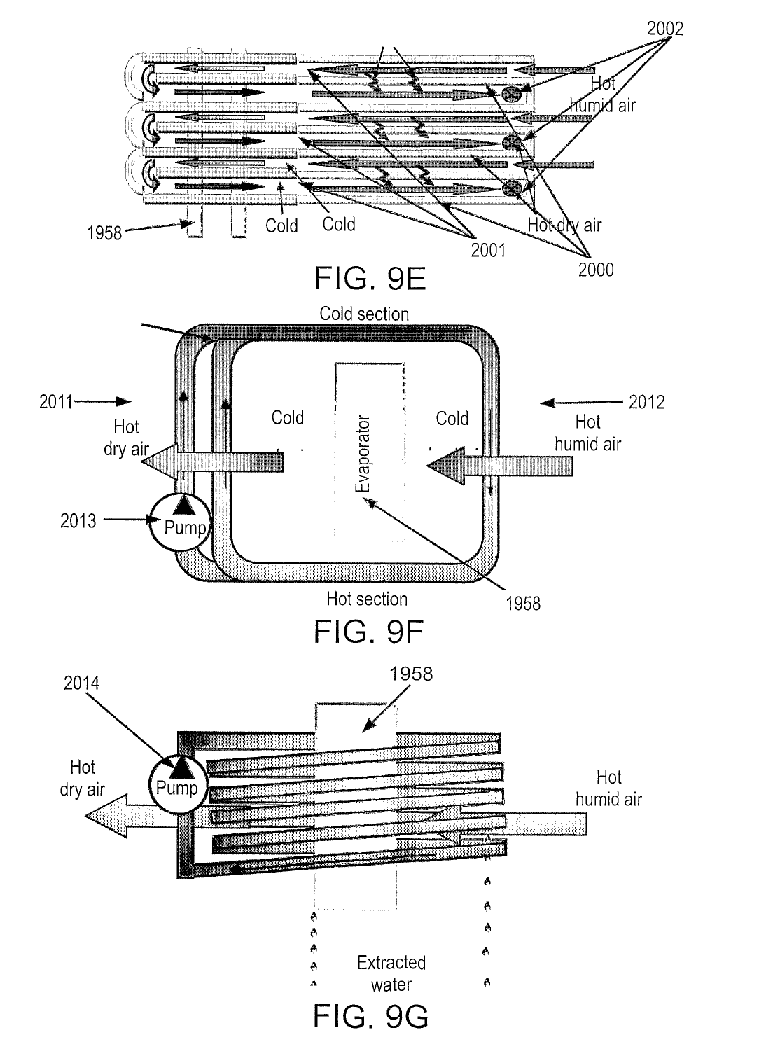

Alternatively when the temperature is less than 15° the heating mode will be operated by the passengers and the water collection may be performed as shown at FIG. 9A and describe below.

According to some embodiments of the present invention there is provided a vehicle integrable device of water production. The vehicle integrable device is designed to be integrated into a vehicle, such as a armored fighting vehicle (AFV), for example by utilizing and/or controlling its power sources, ventilation systems, cooling systems, and/or water reservoirs. The device includes one or more air pumps and/or blowers, for brevity referred to herein as air drawing units, for drawing moist air from the passenger compartment of the AFV and/or the surrounding of the AFV. The AFV further includes a filtering unit for filtering the moist air from organic and inorganic contaminants, for example dust, dirt, chemical, biological, radiological, and nuclear particles and biomolecules. The device is based on a dehumidifying unit that condenses water vapor from the filtered moist air. The dehumidifying unit may be based on a desiccant wheel, one or more condensers, one or more evaporators, a compressor, and/or any other unit that allows dehumidifying air. The condensed water vapor may be accumulated in a water container. In such a manner, the device allows passengers to spend more time in an area without a clean water supply, to convert fuel or electricity supply and/or to utilize the air-conditioner and/or the engines activity for producing liquid water, for brevity referred to herein as water. Optionally, the device's components are cased in a harden housing.

Optionally, the device further comprises one or more water filters. In such an embodiment, water may be periodically filtered using the one or more water filters. Optionally, the device further comprises a UV illumination that allows removing contaminants, such as bacteria and/or viruses, such as e-coli, cholera, typhoid, anthrax and polio from the water.

Optionally, the device includes a dirt filter, such as a cyclonic filter. In such an embodiment, the device may generate water in environmental conditions, such as sand or dirt storms.

Optionally, the device includes automatic cleaning unit that periodically cleans the evaporator, the condenser and/or other parts of dust and/or pollutants.

Optionally, the device includes a water back wash mode that cleans the water filter or and act periodically and longer water filter life and prevent clogs.

According to some embodiments of the present invention there is provided a method for producing water. The method is based on a dehumidifying unit that is integrated into a vehicle, as an AFV. The integration may include connecting the dehumidifying unit the power battery and/or alternator of the vehicle and/or using its cooling and/or ventilation systems. The method is further based on drawing, for example by blowing, moist air, filtering the moist air, for example as outlined above, and condensing the air vapor in the drawn air. The condensed water vapor is accumulated in a water container, providing passengers and/or vehicle system with an amount of water. Optionally, such a water production process is initiated according to the reading of one or more sensors, such as electricity power sensor, humidly sensor, water accumulation sensors, temperature sensors, and the like.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

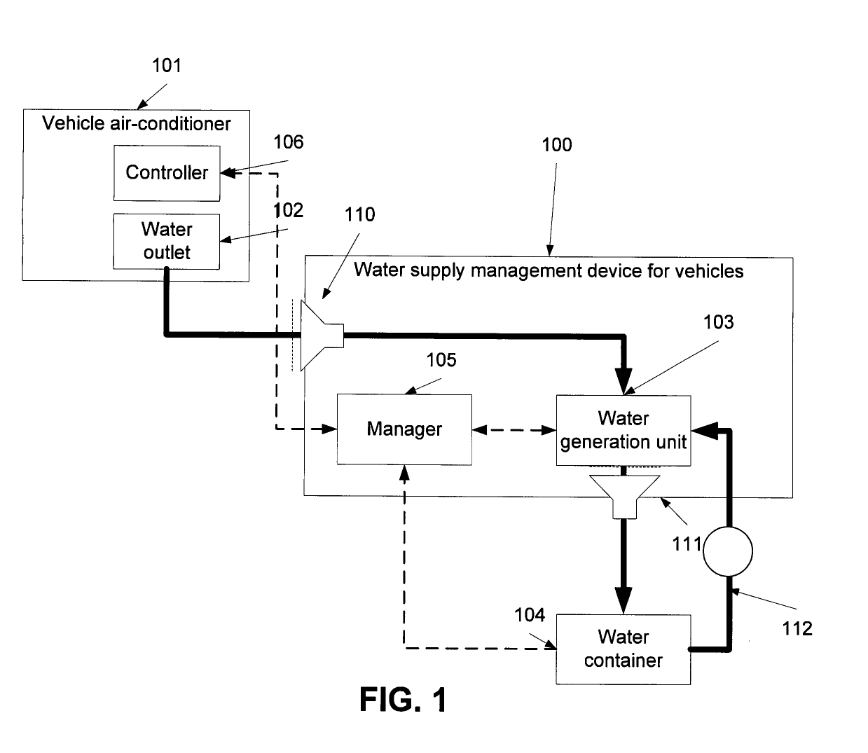

Reference is now made to FIG. 1, which is a schematic illustration of a water management device 100 of managing the supply of water generated as a product of an operation of a vehicle air conditioner 101, according to some embodiments of the present invention.

The water management device 100 conducts water generated as a product of the operation of the vehicle air conditioner 101 to a water container 104, and optionally treats it. As used herein, a vehicle air conditioner means an air conditioner which is integrated with a vehicle, such as a car, an armored fighting vehicle (AFV), a military SUV, a train, an aircraft and a seacraft. For example, the vehicle air conditioner may be the air conditioner used for cooling a passenger compartment. As used herein, treating water means filtering undesired particles from the water, disinfecting the water, deactivating biological substances in water, and/or enriching the water with materials such as salts, glucose, sodium, sweetener and/or carbohydrates, purifying materials, such as iodine and/or drugs.

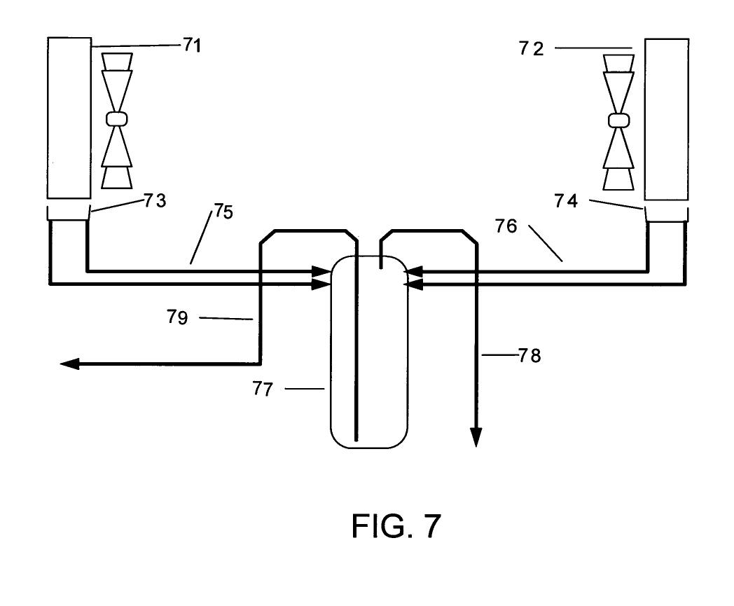

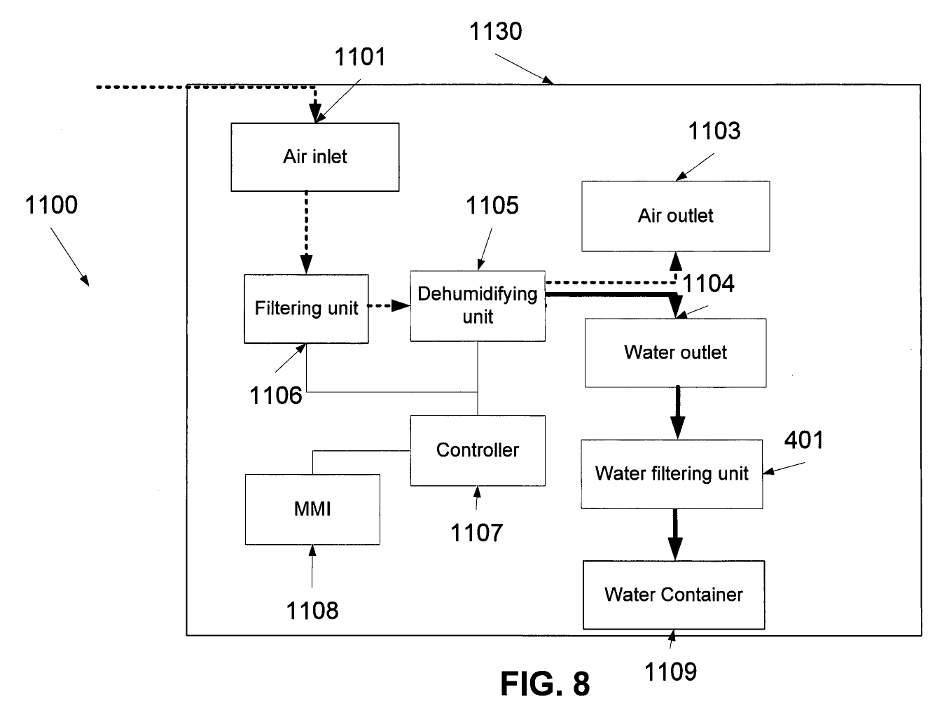

The water management device 100 includes a water inlet 110 that receives water from the vehicle air conditioner 101 and conducts them to a water generation unit 103. In use, the conducted water is optionally treated by the water generation unit 103, for example as the vehicle integrable device that described below with reference to FIGS. 8-13 and in Israeli Patent Application No. 200680, filed on Sep. 1, 2009, which is provided as a priority document and incorporated herein by reference. The water treated by the water filtering unit 221 is conducted, via an outlet 111, to the water container 104.

The water management device 100 further includes a manager 105 that adjusts the operation of the vehicle air conditioner 101 according to one or more indications, such as water consumption, water generation status, water resources, current temperature, current amount of available water as further described below.

Optionally, the manager 105 includes a computing unit such as an application specific integrated circuit, optionally with a digital signal processing (DSP) core, that computes, according to the indications, a set of one or more adjusting instructions for the controller of the vehicle air conditioner 101.

Optionally, the water management device 100 the manager 105 adjusts the operation of the vehicle air conditioner 101 according to the outputs of a temperature sensor for indicating the temperature in the passenger compartment and/or around the vehicle. Optionally, the water management device 100 adjusts the operation of the vehicle air conditioner 101 according to the outputs of a hygrometer for indicating a humidly level in the passenger compartment and/or around the vehicle. Optionally, the manager 105 adjusts the operation of the vehicle air conditioner 101 according to the time of the year, the time in day, and the vehicle geographic location.

Optionally, the components of the water management device 100 are housed in a housing designed to absorb shocks, for example by using shock absorbers as described below and hardened to protect against wear, extreme temperature, chemicals, small arms fire and grenades. Optionally, a layer of an alloy, such as stainless steel alloy, is used for hardening the housing. Optionally, some or all of the passages, in which the drawn air pass, are coated with a protective layer, such as a polymeric layer. In such a manner, the water vapor is not exposed to metal, gases, and/or other toxic materials.

Optionally, the water management device 100 is powered by a power source of the vehicle to which it is integrated, such as the battery and/or alternator. Optionally, the power source provides an AC current voltage in between 90 and 480 volts between 50 and 60 hertz or any intermediate value and/or a DC current voltage between 12 and 150 volts. Optionally, the water management device 100 runs at 400 hertz. In such a manner, the power supplies are smaller and lighter. This benefit is important as the space in the vehicle is limited and it is imperative to minimize weight in order to maximize performance. Optionally, the water management device 100 is connected to the power source via a commonly used military power connection, a vehicle battery, a designated battery or any combination thereof. Optionally, the water management device 100 comprises an alternator or any other power convertor that is connected to the engine's crankshaft. In such an embodiment, the power generated by the engine is directly converted to facilitate the dehumidification of water vapor.

According to some embodiments of the present invention, the vehicle air conditioner 101 is adjusted for water generation usage. In such embodiments, cooling coils, a chamber in which the cooling coils are found, water conduits, and/or any element which is in touch with the processed air and/or treated water is laminated or otherwise covered with a protective layer that prevents from the air and/or the treated water to be in touch with metal components of the vehicle air conditioner 101. Optionally, all the soldering portions are laminated or otherwise covered with a protective layer. Optionally, only the soldering portions are laminated or otherwise covered with a protective layer. Optionally, the surface of the condenser is reduced and one or more tray for collecting water is placed below the evaporator, and/or the condenser.

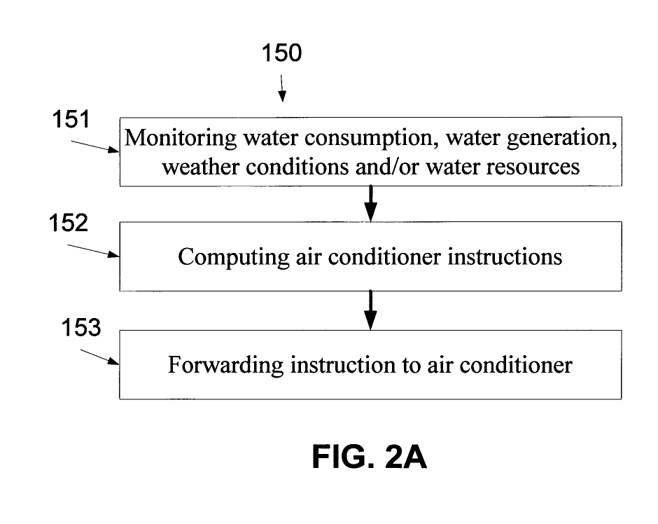

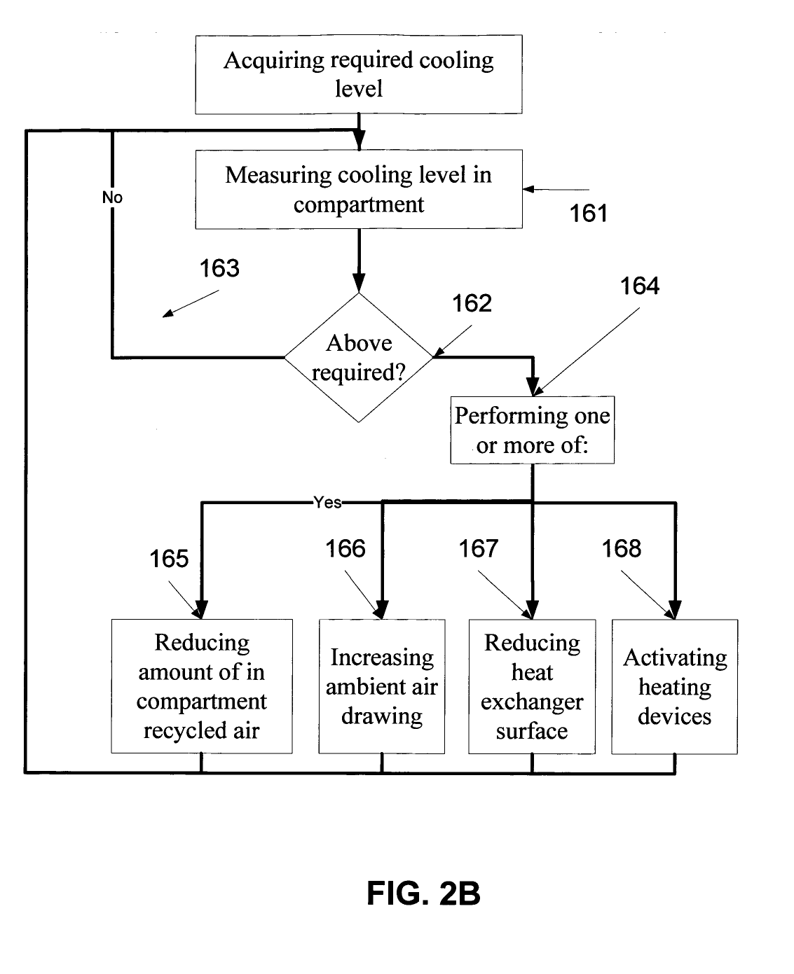

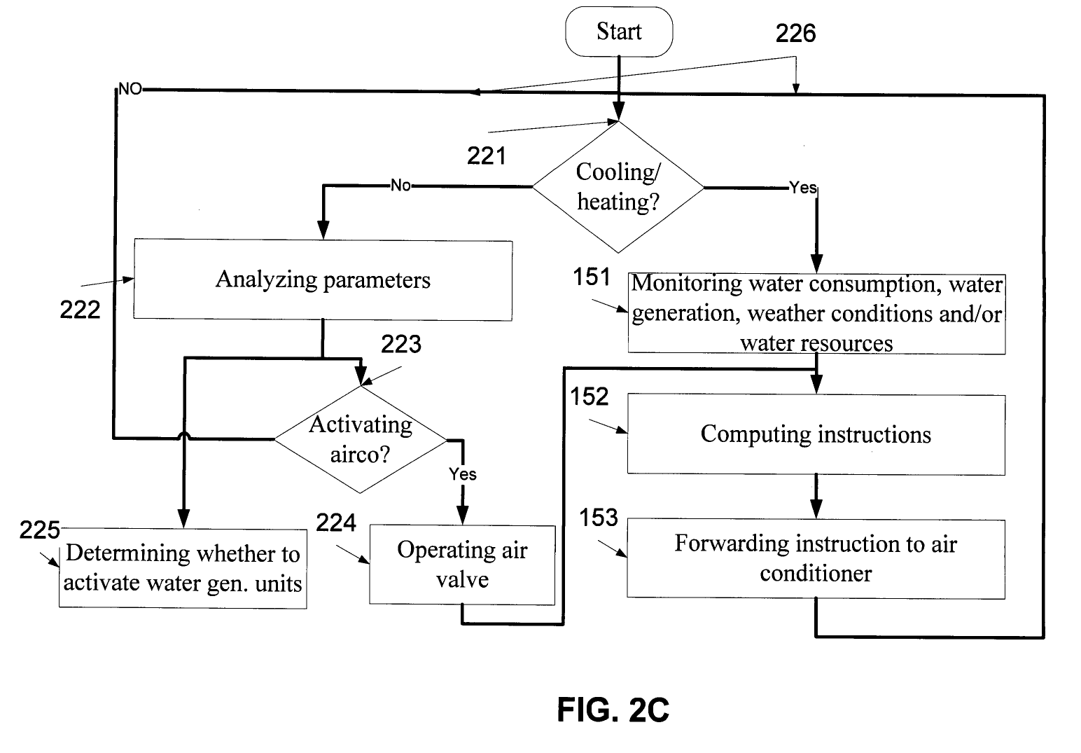

Reference is now also made to FIG. 2A, which is a flowchart 150 of a method of operating a vehicle air conditioner according to water consumption, water generation status, and/or water resources, according to some embodiments of the present invention.

First, as shown at 151, parameters related to the water consumption, the water generation, weather conditions and/or water resources in the vehicle are monitored. For example, the amount of water in the water container 104 is monitored, optionally in light of estimated water consumption determined according to the amount of potential consumers, temperature, humidity level and/or time of the day.

Than, as shown at 152, air conditioner instructions are computed, for example by the manager 105, for adjusting the operation of the vehicle air conditioner 101 according to the monitored parameters, for example as described below.

Now, as shown at 153, the air conditioner instructions are forwarded to the vehicle air conditioner 101 so as to allow the adjustment of its operation according to the water consumption, water generation status, and/or available water resources.

Optionally, the manager 105 computes air conditioner instructions for adjusting the operation of the vehicle air conditioner 101 according to one or more inputs from sensors and/or other units of the device 100. In such embodiments, the manager 105 is electrically connected, wirelessly or with wires, to the controller of the vehicle air conditioner 101 and/or replaces the controller of the vehicle air conditioner 101. The vehicle air conditioner instructions are coded to adjust the operation of the vehicle air conditioner 101. For example, the instructions are coded to increase the operation of the compressor so as to increase the amount of water generated by the vehicle air conditioner 101. In another example, the instructions are coded to reduce the air supply, reducing the active portion of the condenser, diverting some or all of the air away from the passenger compartment, gathering water from an external condenser when the system is in a heating mode (see FIG. 9A for example), and/or using a hot bypass gas to deforest the radiators.

According to some embodiments of the present invention, the manager 105 computes air conditioner instructions according to weather condition, for example temperature and/or humidity level. For example, if the temperature is relatively low for example 15° C. and/or the humidity level is relatively low, for example less than 25% RH, the air conditioner instructions adjust the operation of the vehicle air conditioner 101 to operate in a low air supply mode, for example about a half of the air supply of the regular air supply thereof. In such a manner, the evaporation temperature is reduced, for example to less than −3° and the water generation throughput increases, for example to more than 2.0 Liter (Ltr)/Hr.

For example, if the vehicle air conditioner 101 has a cooling output of 14 KW, the temperature is lower than 30°, and the humidity level is less than 20% Relative humidity (RH), the received evaporation temperature is about 5° and the vehicle air conditioner 101 does not produce much water. However, if the air supply is reduced to about a half of the common air supply, the received evaporation temperature is about −6° and the water production increases to about 2.5 Ltr per hour (Hr).

In another example, if the vehicle air conditioner 101 has a cooling output of 14 KW, the temperature is lower than 15°, and the humidity level is less than 25% Relative humidity (RH), the received evaporation temperature is about −1° and the vehicle air conditioner 101 does not produce much water. However, if the air supply is reduced to about a half of the common air supply, the received evaporation temperature is about −12° and the water production increases to about 1.2 Ltr/Hr.

According to some embodiments of the present invention, the computes air conditioner instructions are computed to increase the water production output if the cooling capacity of the vehicle air conditioner is higher than a heat load at the passenger compartment of the vehicle. As used herein a cooling capacity refers to the rate heat is removed from the passenger compartment, under weather conditions, for example rated in British Thermal Units (BTUs) per hour, or in tons and heat load means the amount of heat required to be removed within a certain period, for example in BTU or watts. The heat load may be determined by measuring the temperature and/or humidity in the passenger compartment. The cooling capacity may be provided in advance, based on standard weather conditions and/or dynamically changed according to up-to-date measurements of respective weather sensors. In such embodiments, the manager 105 may communicate with the controller of the vehicle air conditioner 101 to receive data regarding to the required cooling level and/or the current cooling status. Optionally, the manager 105 is connected to a thermometer and/or hygrometer which are used to measure the current temperature and/or humidity in the passenger compartment and optionally to calculate a heat load value. The water production output is increased by allocating a portion of the cooling capacity for this purpose. For example, the amount of the air from the passenger compartment that is recycled by the vehicle air conditioner 101 for cooling is reduced or stopped, the amount of ambient air that is drawn by the vehicle air conditioner 101 for cooling is increased and/or the active surface of the heat exchanger of the evaporator of the vehicle air conditioner 101 is reduced.

According to some embodiments of the present invention, the computes air conditioner instructions to increase the water production output in light of a required cooling level in the passenger compartment. In such embodiments, the manager 105 may communicate with the controller of the vehicle air conditioner 101 to receive data regarding to the required cooling level and/or the current cooling status.

Reference is now made to FIG. 2B which is a flowchart of a method for instructing the operation of the air conditioner according to a required cooling level in the passenger compartment, according to some embodiments of the present invention. First, as shown at 161, a required cooling level is acquired. The required cooling level may be manually set by a user, for example using the aforementioned MMI, and/or automatically acquired, for example by the manager 105 and/or from a memory. Now, as shown at 162, the current cooling level is measured and/or acquired, for example from the manager 105. Optionally, the manager 105 is connected to a thermometer and/or hygrometer which are used to measure the current temperature and/or humidity in the passenger compartment and optionally to calculate a heat load value. If the measured temperature in below the required cooling level, as shown at 163, nothing is done. However, if the measured temperature is above the required cooling level, as shown at 164, the manager instructs the controller of the vehicle air conditioner 101 to change one or more parameters. The cooling level is optionally defined according to a heat load value, such as heat load temperature and/or humidity. Optionally, as shown at 165, the amount of the air from the passenger compartment that is recycled by the vehicle air conditioner 101 for cooling is reduced or stopped. Additionally or alternatively, as shown at 166, the amount of ambient air that is drawn by the vehicle air conditioner 101 for cooling is increased. Additionally or alternatively, as shown at 167, the active surface of the heat exchanger of the evaporator of the vehicle air conditioner 101 is reduced. It should be noted that the required cooling level may be not to cool the passenger compartment at all. In such a case, all the throughput of the air conditioner is used for generating water. Additionally or alternatively, as shown at 168. one or more heating elements may be activated for heating the passenger compartment to a required temperature.

Optionally, the heating elements are activated by the heat exchanger of the cooling water of the vehicle. The heating elements are activated to balance unnecessary cooling of the passenger compartment. In such an embodiment, the air conditioner may be operated even when the temperature in the passenger compartment is lower than required and/or as required.

According to some embodiments of the present invention, a supplementary evaporator is connected to the cooling gas tubing of the vehicle air conditioner 101, optionally in addition to the internal evaporator thereof. Optionally, the supplementary evaporator directs cooled air away from the passenger compartment. The combination of the supplementary evaporator and the compressor of the vehicle air conditioner 101, instead or in addition to the internal evaporator, allows generating a relatively large amount of water in low evaporation temperature and/or relatively low humidity level. Alternatively, a set of one or more valves is connected to control the heat exchange of the evaporator. The valves allow reducing the cooling output of the evaporator by changing the effective area thereof, for example to half, achieving a similar effect to using the supplementary evaporator.

For example, if the vehicle air conditioner 101 has a cooling output of 14 KW, the temperature is lower than 20°, and the humidity level is less than 20% Relative humidity (RH), the received evaporation temperature is about 6° and the vehicle air conditioner 101 does not produce much water. However, if a supplementary evaporator with about a half cooling output is used with the compressor of the vehicle air conditioner 101 or the valve reduces the cooling output to half, the received evaporation temperature is about −3° and the water production increases to about 3.5 Liter (Ltr) per hour (Hr).

In another example, the vehicle air conditioner 101 has a cooling output of 14 KW, the temperature is lower than 15°, and the humidity level is less than 25% Relative humidity (RH), the received evaporation temperature is about −1° and the vehicle air conditioner 101 does not produce much water. However, if a supplementary evaporator with about a half cooling output is used with the compressor of the vehicle air conditioner 101 or the valve reduces the cooling output to half, the received evaporation temperature is about −10° and the water production increases to about 2.0 Liter (Ltr) per hour (Hr).

Reference is now also made to FIG. 2C, which is another flowchart 220 of a method of operating a vehicle air conditioner as shown at FIG. 2A where the method further includes operations performed when the vehicle air conditioner in not used for cooling and/or heating the passenger compartment, according to some embodiments of the present invention.

As shown at 221, if the vehicle air conditioner 100 cools or heats the passenger compartment, the operation is as described in relation to FIG. 2A. Else, as shown at 222, one or more parameters are analyzed for determining whether to activate the vehicle air conditioner 101 for producing water. For example, the parameters may be any one or any combinations of the following: the amount of water in the water container 104, the weather condition, an estimation about the amount of water generated in the current weather condition, the amount energy required for generating water in the current weather condition, the amount of fuel left in the fuel talk, the amount of consumers in the vehicle, the time of the day and the like. These parameters may be measured via respective sensors, for example as described below and in Israeli Patent Application No. 200680, filed on Sep. 1, 2009 which is incorporated herein by reference and/or provided from a repository that stores these parameters. As shown at 223, the parameters allow determining whether to operate the vehicle air conditioner 101 or not.

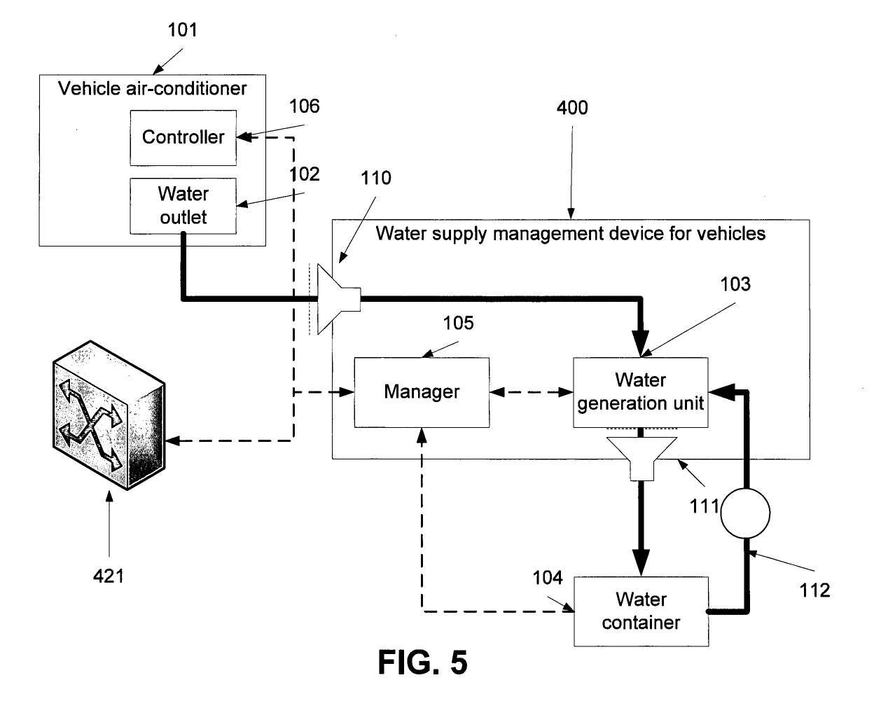

Optionally, as shown at 224, an air valve is instructed to direct the hot and/or cooled air away from the passenger compartment, for example as described below in relation to FIG. 5. Optionally, as shown at 152-153 and described above, instructions for how to operate the vehicle air conditioner 101 are calculated and forwarded. Optionally, as shown at 225 a decision to operate one or more water generation units is taken based on the aforementioned parameters. As shown at 226, this process may be iteratively repeated, each time with current parameters and/or current air conditioner activity.

According to some embodiments of the present invention, the water management device 100 treats water produced when the vehicle air conditioner 101 operates in a heating mode. Optionally, the vehicle air conditioner 101 is a reverse cycle air conditioner having a reversible refrigeration cycle that produces, when reversed, heat instead of cold. When the refrigeration cycle is reversed, ambient air is circulated around and condensed on the peripheral surface of a cold evaporator that serves as a heat exchanger. In such an embodiment, a container is placed below, the cold evaporator, gathers the water toward an aperture of a drainpipe that carries water generation unit 103. For example, see FIG. 9A and the description below.

Optionally, in use, the manager 105 computes whether the vehicle air conditioner 101 produces more water in a refrigeration mode or in a heating mode and instructs, accordingly, the controller of the vehicle air conditioner 101 to switch between them. Optionally, such a switch is performed when the air valve directs the hot and/or cooled air away from the passenger compartment. For brevity, it should be noted, that each one of the embodiments in which a cool air is produced by the vehicle air conditioner 101 may be respectively implemented, mutatis mutandis, when a hot air is produced by the vehicle air conditioner 101. For example, see FIG. 9A and the description below. Optionally, in use, the manager 105 is connected to a detector which is set to measure the air supply of the vehicle air conditioner 101. In such an embodiment, the manager 105 may instruct the controller to increase or decrease the power of the blower of the vehicle air conditioner 101 until the air supply is as required for producing water efficiently and/or economically, for example as described herein. In such a manner, dust or dirt which accumulate in the filters of the vehicle air conditioner 101 do not substantially reduce the water production output,

Optionally, the manager 105 is connected, wirelessly or with wires, to a man machine interface (MMI), such as a keypad, a set of buttons, a touch screen, and the like. Optionally, the MMI is a remote control that communicates with the manager 105 using a wireless interface, such as wireless local area network (WLAN) interface, such as WiFi™ interface and Bluetooth™ interface and/or a wired connection, such as a coaxial cable connection. In such embodiments, an operator may input instructions for adjusting the operation of the vehicle air conditioner 101. Optionally, the MMI allows the user both to control the vehicle air conditioner 101 and to input instructions for adjusting the water generation thereof, and optionally of other components of the water management device 100. Optionally, the MMI allows the user to select among various operation modes, each indicates on different water output levels, energy consumption levels, and/or cooling levels. Optionally, the MMI allows the user to control the air valve described below. Optionally, the MMI is replaces and/or includes the control of the vehicle air conditioner 101. When the water management device 100 is installed in existing vehicles, namely not installed during the initial make-up of the vehicle, the MMI is installed, and optionally placed, instead of the original control of the vehicle air conditioner 101.

Optionally, the MMI includes a control that allows an operator to switch between various modes, for example two or more of the following options air conditioning mode, air conditioning mode combined with water generation mode, water generation mode only, and water treatment only. The selection of the operator determines whether the air switch directs the air flow toward the passenger compartment, whether the vehicle air conditioner 101 is activated and how, whether the water in the water container are circulated and the like. Other operation modes which are derivatives of the functionalities described below may also be selected by the operator. Optionally, the MMI is connected to sensors that monitor the water in the water container 104, for example the amount of water in the water container 104 and their cleansing level. In such an embodiment, the MMI may present respective indications and/or alerts to the operator.

Optionally, the manager 105 is electrically connected, wirelessly or with wires, to a measuring gauge that measures and indicates the amount of water in the water container 104. Optionally, the measuring gauge uses a float connected to a resistor. As the water 104 tank empties, the float drops and slides a moving contact along the resistor, changes its resistance. Different resistances are indicative of different water levels.

In such embodiments, the manager 105 may adjust the operation of the vehicle air conditioner 101 according to the different water levels, for example increase or decrease the power consumed for the operation.

Additionally or alternatively, the manager 105 computes the vehicle air conditioner instructions according to dynamic parameters, such as a variable water consumption according to the number of potential water consumers, for example passengers in the vehicle, the time of the day, the time of the year, the temperature in the passenger compartment, and/or the temperature outside of the passenger compartment.

Additionally or alternatively, the manager 105 computes the vehicle air conditioner instructions according to vehicle parameters, for example the amount of fuel in the fuel tank, the current fuel consumption, the driving mode, and/or any other vehicle parameter.

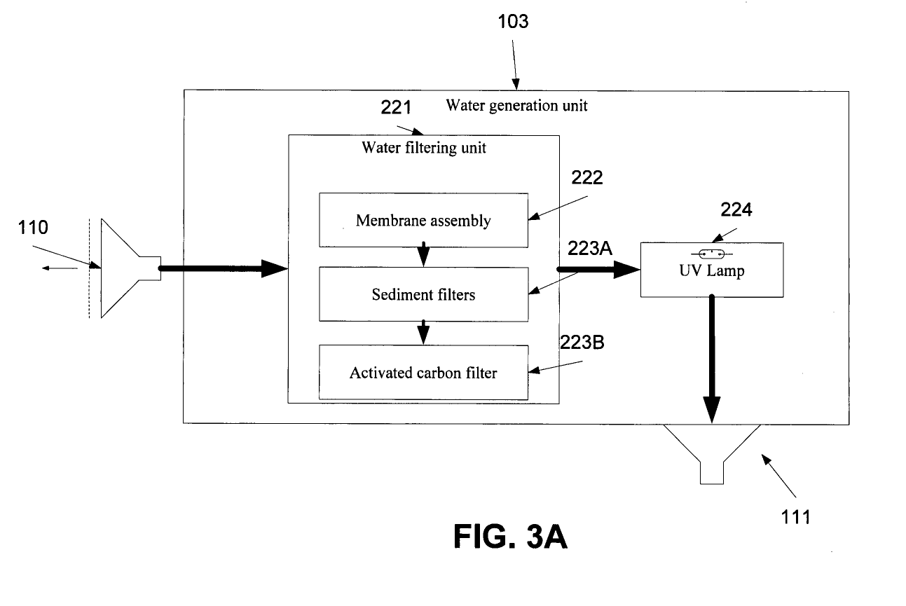

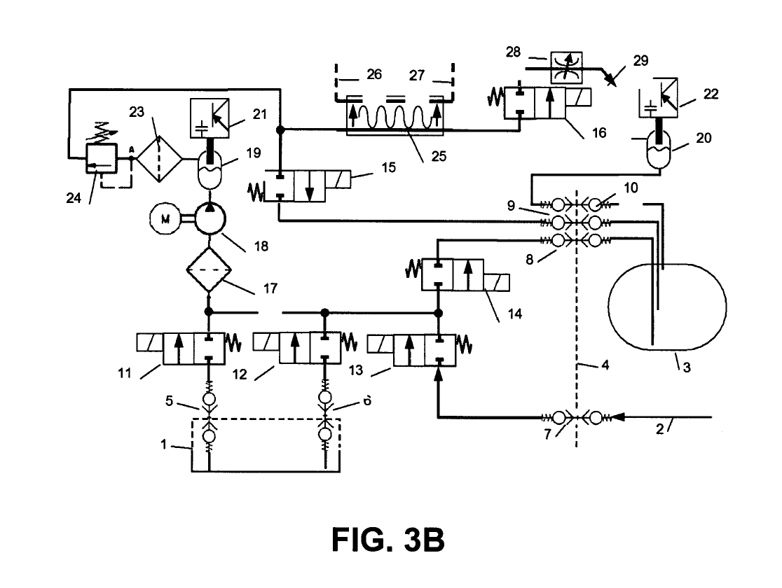

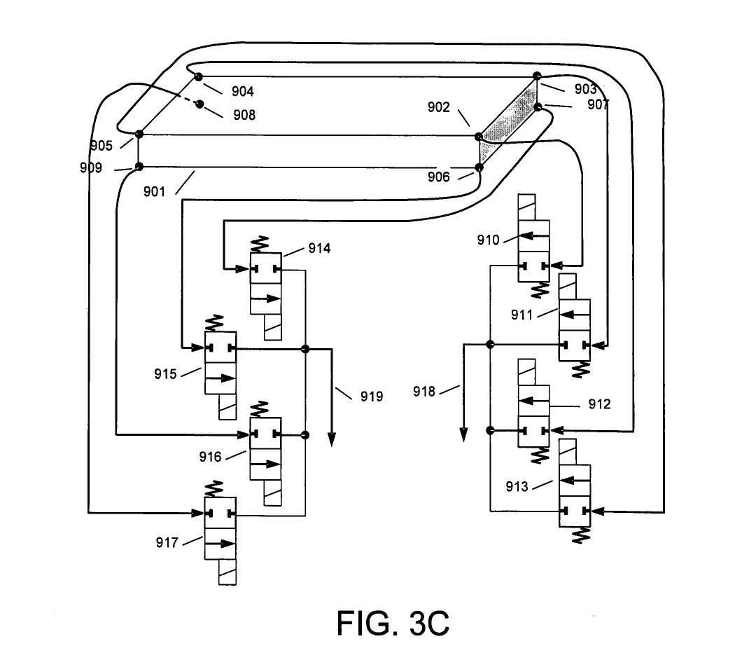

Reference is now made to FIG. 3A, which is a sectional schematic illustration of exemplary components of a water treatment unit, such as shown at 103, according to some embodiments of the present invention. Optionally, the water generation unit 103 includes a water filtering unit 221, for example of reverse osmosis (RO) filtering, with a set of water filtering components 222-223. Optionally, in use, the water from the vehicle air conditioner 101 are conducted toward a membrane assembly 222, optionally RO membrane, having a pressure vessel that presses the water against the thin film composite membrane, such as a spiral-wound membrane and a hollow-fiber membrane. The thin film composite membrane traps pollutants and microorganisms from the pressed water. Optionally, the filter is a 5 micron water filter.

Optionally, the thin film composite membrane includes one or more layers of microfiltration (MF) membranes for rejecting suspended particles and high molecular weight compounds, ultrafiltration (UF) membranes, and/or nanofiltration (NF) membranes for rejecting low molecular weight compounds and ions the MF membranes reject. Optionally, the membrane is made from cellulose acetate (CA) and/or polyamide thin film composite (TFC). Optionally, the one or more membranes remove particles having a diameter of more than 0.1 mm. Optionally, the membranes purify salt water and water contaminated with CBRN (NBC) agents from the water.

Additionally or alternatively, a silver ions filter that releases silver ions in a controlled manner to exchange positive ions such as sodium is used. For example, the silver ions filter is as defined in OMNIPURE, “K5520-AM filter”, www.omnipure.com/data_sheets/K/K5520.pdf, which is incorporated herein by reference.

Additionally or alternatively a copper-zinc filter, such as a Kinetic Degradation Fluxion (KDF) water filter is used. This filter uses a chemical process known as redox oxidation/reduction to remove chlorine, lead, mercury, iron, and hydrogen sulfide from water supplies. The process also has a mild anti-bacterial, algaecitic, and fungicitic, effect and may reduce the accumulation of lime scale.

Additionally or alternatively a pH reducer device is used for reducing the pH in the treated water so as to improve mineral absorption. Optionally, the pH reducer device includes acid neutralizing filters and/or a chemical feed pump system that injects a neutralizing solution, also known as pH reducer or decreaser. An acid neutralizing filter uses a calcite, iodine crystal, and/or calcium carbonate for normal pH correction, but could also include a blend of magnesium oxide and calcite, if the pH is very low. Since the water absorbs these minerals when it passes through the filter, the alkalinity and hardness increase. Optionally, the acid neutralizing filters include silver oxide and/or silver chloride.

Optionally, the water filtering unit 221 outlets is connected to a mineralizer for adding minerals and/or flavor to the treated water. Optionally, the mineralizer is connected to one or more mineral sensors which provide indications pertaining to the salt level in the water. In such an embodiment, the operation of the mineralizer may be triggered or controlled by these indications.

Optionally, the water filtering unit 221 conducts water via one or more sediment filters 223A, such as fiber rolls or wattles, each configured for trapping particles having a diameter over a certain threshold before arriving at the membrane assembly 222. Optionally, the first sediment filter is used for capturing particles having a diameter of more than 5 mm and a second sediment filter is used for capturing particles having a diameter of more than 3 mm and so on and so forth. Optionally, the diameter of the captured particles is determined according to the size of the pores of the sediment filters. Optionally, the water filtering unit 221 removes filtered particles via a drain.

Additionally or alternatively, the water filtering unit 221 further conducts the water via an activated carbon filter 223B that traps organic chemicals, such as herbicides and pesticides, and may also remove objectionable tastes and odors, before arriving at the membrane assembly 222.

Additionally or alternatively, the water filtering unit 221 further includes a carbon filter (not shown) that is placed to trap chemicals which are not removed by the RO membrane.

Additionally or alternatively, the water filtering unit 221 conducts the water in front of a ultra-violet lamp 224 for disinfecting microbes which are not removed by the RO membrane. Optionally, the UV illumination is concentrated in the 254 nanometers (nm) region so as to allow removing some or all of the bacteria and/or viruses, such as e-coli, cholera, typhoid, anthrax and polio in the water.

Optionally, the ultra-violet lamp 224 is housed in an ultraviolet disinfection sterilizer tube, such the UV bulb of TAMI™ that the specification thereof is incorporated herein by reference. The tube is energized by embedded ballast having a power supply of 12 V_{DC}, 1.8A_{DC}. The supply is done by a switch-mode power supply SMPS-DC/DC converter from 24V_{DC} to 12V_{DC}, 25 W, for example MEAN WELL, “25 W Single Output DC-DC Converter, PN SD-25B-12 (24V_{DC}/12V_{DC}, 2.1 A, 25 W) which the specification thereof is incorporated herein by reference.

Reference is now made to FIG. 3B, which is a schematic illustration of an exemplary water generation unit 103, according to some embodiments of the present invention. The water generation unit 103 includes a water inlet 2 for receiving water from the vehicle air conditioner, and optionally from one or more water generation units, and a treat water output 1, such as a water collection tray, optionally detachable. The water from the tray is conducted to a water container 3, such as 104. Dotted line 4 depicts optional separation between the water container 3 and the water generation unit 103. Numerals 5-10 depict various coupling fluid connections that allows detachably connecting and releasing the tray 1 and the water container 3. Numeral 18 depicts electrically motorized diaphragm pump. Numeral 17 depicts a mesh filter that filters dirt from reaching the pump 18. The pump 18 drives the water in the water generation unit 103. The pump 18 pumps water originated from the vehicle air conditioner 101 and/or other water generation units from the collection tray 1. Numerals 11-16 depict various fluid valves that allow receiving or rejecting water from the vehicle air conditioner 101 and/or other water generation units. The pumped water passes via a water presence detection tube 19 that detects water by a water presence detector capacitive proximity sensor 21. Then, the water flows through a water quality improvement filter(s) 23, such as one or more of the aforementioned filters. Water leaving the filter(s) 23 flow through a pressure regulator 24 that regulates the water pressure to a predetermined value suitable for use. Water flows from the pressure regulator 24, for example the Pressure regulator of CAMOZZI, PN: M004-R00, which the specification thereof is incorporated herein by reference, to the water reservoir tank 3 and/or out for use, via a pouring nozzle 28. Numeral 20 depicts a water presence detection tube for monitoring water in the water container and numeral 22 depicts water presence detection capacitive proximity sensor for monitoring water in the water container. Numeral 25 depicts a heat exchange water cooling element which cools the water by conducting refrigerant gas. Numerals 26-27 depict heat exchange refrigerant gas entries. Numeral 27 depicts a flow restrictor.

Optionally, the water generation unit 103 is adapted to operate also when the vehicle is inclined, for example in 15 degrees relative to the horizon or more, for example 20 degrees or even in 45 degrees relative to the horizon, in order to enable withdrawal of the water when the vehicle is diagonally oriented. Optionally, water is alternately withdrawn through both the left and the right connections 5, 6 which are placed in the left and the right low side of the tray 1. In such a manner, water from one of the sides of the tray 1 is pumped. If water is not present at any side air is pumped. This process is done periodically, with predetermined period, base on calculation of water extraction throughput. Optionally, valves which are connected to an angle sensor open and close the connections 5, 6. When air is pumped instead of water, for example when the vehicle air conditioner 101 stops and water is no longer sensed by the sensor 21, the pump 18 is put on hold or shut down by the manager 105 or any other controller, referred to herein, for brevity, the manager 105. Water pumped from water container 3 flows through quick coupling fluid connection 8 then through solenoid valve SV4 14 and via filter 17 by the pump 18. In such a manner, the water in the water container 3 are cycled, similarly to the described below. Water pumped to the water container 3 pass via the pressure regulator 24, the solenoid valve 15, and the quick coupling fluid connection 9. Optionally, air pressure may be released from the water container 3 so as to allow the filling thereof with water. The air pressure release is done via quick coupling fluid connection 10, water presence detection tube 20 and emitted from tube 20 outlet. When the tank water container 3 is filled-up water overflows through the air pressure released path. When water reaches capsule 20 it is detected by the water presence detector capacitive proximity sensor 22 and a signal therefrom is forwarded to the manager 105 that shuts the pump 18 down. Optionally, the spilled water is routed to the tray 1.

Reference is now also made to FIG. 3C, which is a schematic illustration of a means of pumping water from a tray or a container inclined in relation to the horizon, according to some embodiments of the present invention. As outlined above, the water generation unit 103 may be adapted to operate when the vehicle is inclined. Optionally, the water generation unit 103 uses a mechanism for facilitating such pumping, for example the means depicted in FIG. 3C.

Using such a mechanism allows drawing water from the water container even when it is relatively empty, for example when the water level is shorter than the width of a water container. FIG. 3C depicts a water container 901, such as the water container 104 depicted in FIG. 1, or a tray, such as the trays 73 74 in FIG. 9A. The water container 901 has apertures in at least two of its lower left, lower right, optionally upper left, and upper right corners. It should be noted that even though FIG. 3C depicts a water container with a rectangular base, the water container 901 may be conical, cubical, spherical, cylindrical, triangular, tetrahedral star-like, or pyramid in shape. The corners are respectively selected so that water is inclined toward it when the vehicle is inclined to its left and/or right sides. For example, eight apertures are set in corners 902-909, 4 of them 902-905 at the top of the water container 901 and 4 others 906-909 at its bottom. The corners 902-909 are optionally at the endmost corners in relation to the center of the water container 901.

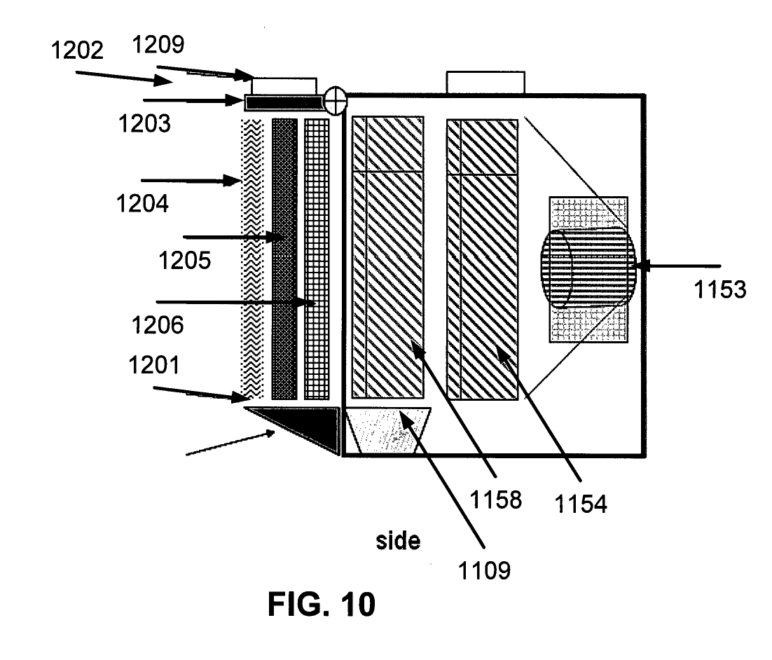

At each of the corners 902-909, a tubing connection is made and a tube is drawn to the water generation unit 103. Each tube is connected to a corresponding solenoid valve, for example the solenoid valves depicted in FIG. 3B. The top tubes are connected to solenoid valves 910-913 and bottom tubes are connected are connected to solenoid valves 914-917. The solenoid valves, which are optionally as described in relation to FIG. 3B, are controlled by the manager 105 so that drawing may be performed from one or more of the top connections 902-905 and/or one or more of the bottom connections 906-909. Optionally, the valves are controlled according to a predetermined scheme, for example left-right, left-right and the like. In such an embodiment no sensor may be used. In other embodiments, the control is determined according to readings of various sensors, for example as outlined above and described below. The selected connection(s) from the top group 918 and/or the selected connection(s) from the bottom group 919 are used to withdraw water from the water container 901, and optionally to circulate them via the water generation unit 103. The mechanism depicted in FIG. 10 does not require using a dedicated pressure release connection. When filling or withdrawing water, the bottom connection(s) are used via tube 919 and pressure release is done via the top connection(s) and tube 918. Additional valves (not shown) may by placed along tubes 918 and 919 for facilitating the pressure realize in a controllable manner. The circulation of water via tube 919 and tube 918, for example as described above, does not require pressure release.

Optionally, the manager 105 selects the connections, in real time, according to readings of fluid sensors located in the water container, for example at the highest and lowest corners of the water container. Optionally, the manager 105 selects the connections in real time according to readings of an inclinometer. If the vehicle is in motion, acceleration waves of the water in the water container 901 are taken into account. Such indications may be measured by an accelerometer or the like. The combination of the accelerations and the inclining of the vehicle indicate from which corners water is drawn when the vehicle is in motion and/or stationary. Optionally, the inclinometer and accelerometer are at the same orientation of the vehicle. Optionally, the mechanism described in FIG. 3C is used for the collection of water from the water container 901 and/or from the water collection tray 73, 74 described below in relation to FIG. 9A.

Optionally, the water container 901, which may be as the water container 104 or as one of the trays 73 74 in FIG. 9A is opaque so as to prevent microorganism contamination.

Reference is now made, once again, to FIG. 1. As described above, the water treated by the water filtering unit 221 is conducted, via the outlet 111, to the water container 104.

According to some embodiments of the present invention, the water container 104 receives water from additional sources which are located in and/or on the vehicle, for example from water generation units, a water inlet, and/or rain water collecting system. The water container 104 may be external to the water management device 100, for example the water container 104 of an armored fighting vehicle (AFV), an airplane, a train and the like. The water container 104 may be an integral part of the water management device 100.

Optionally, as shown at 112, water from the water container 104 may be re-conducted via the water treatment unit 104. Optionally, the water in the water container 104 is periodically, randomly, and/or continuously circulated via the water treatment unit 104. In such a manner, water in the water container is treated even if it is not a product of the vehicle air conditioner 101 and/or not recently collected. Optionally, the water in the water container 109 are circulated via the water treatment unit 104 according to the outputs of one or more water quality sensors, such as dissolved oxygen, pH, turbidity, temperature, and salinity sensors, passed via the water treatment unit 104. In such an embodiment, a pump 113, such as a booster pump, is used for circulating the water from the water container 104 via the water treatment unit 104. A periodic circulation of the water in the water treatment unit 104 via the water treatment unit 104 maintains the purity level of the water and prevents the growth of algae, bacterial plaque and/or biofilms in the water container 104.

Optionally, the water container 104 has a tap that allows passengers to drink or otherwise use the contained water. It should be noted that as the water is a product of the operation of the vehicle air conditioner 101 there temperature is relatively low. Optionally, the water container 104 comprises a number of separated water cells.

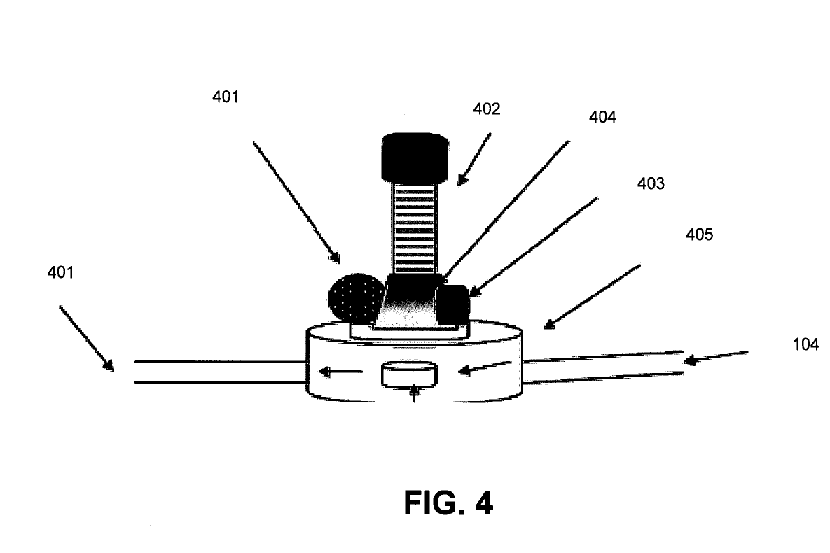

According to some embodiments of the present invention, the water generation unit 103 enriches the water produced by the vehicle air conditioner 101. Reference is now also made to FIG. 4, which is a schematic illustration of an enrichment unit 401 which is integrated with the water generation unit 103, for example as a unit which added to the outlet of the filtering unit depicted in FIG. 3A, according to some embodiments of the present invention. The enrichment unit 401 allows enriching the water, for example by converting them to isotonic water and/or energy water and/or sports water. Optionally, the water is enriched with enrichment materials such as salts, glucose, sodium, sweetener and/or carbohydrates, purifying materials, such as iodine and/or drugs. Optionally, the enrichment unit 401 manages a battery 402 of enriching tablets, powder and/or liquid. In use, the enrichment unit 401 releases one or more enriching tablets and/or powder and/or liquid periodically, randomly, and/or continuously and/or according to the output of a water quality sensor and/or according to the to the quantity of water in the water container 109. Optionally, the tablet is released by an electronic lever 404. Optionally, the enrichment unit 401 is controlled by the controller 106 and/or activated manually, for example by a push button 403. Optionally, the tablet, the powder, and/or the liquid are released using a solenoid valve 403. Optionally, the enrichment unit 401 is designed to release different enrichment ingredients in response to different triggers and/or needs. Optionally, the enrichment unit 401 is connected to a designated portion 405 in a duct that connects the water inlet 104 from the vehicle air conditioner 101 to the water container 104. An exemplary composition of a tablet has the following notorious value per unit: 140 Energy kcals, 33 g Carbohydrate, fat, 235 mg sodium, 4.8 mg Potassium, 3.05 mg Niacin, 1.02 mg Antithetic acid, 1.7 mg Vitamin B6, and 0.85 Vitamin B12. Optionally, the tablet, the powder, and/or the liquid are used for sterilizing the water, for example by adding sterilizing agents to the water, for example Highly-Soluble Chlorinated Sanitize. Optionally, the sterilizing agents are released to enrich water which is used to clean the system, for example as described above.

Reference is now made to FIG. 5, which is a schematic illustration of a device 400 of managing an operation of an air valve 421, according to some embodiments of the present invention. In FIG. 5, the device 400 is similar to water management device 100 depicted in FIG. 1, however, the manager 105 controls an air valve that directs cooled air from the vehicle air conditioner 101. As described above, the water management device 100, 400 manages the supply of treated water generated as a product of the operation of the vehicle air conditioner 101. However, as the vehicle air conditioner 101 also cools the passenger compartment, operating the vehicle air conditioner 101 for providing water may have an undesirable affect of cooling and/or overcooling the passenger compartment and/or wasting the cooled air. In order to avoid such cooling and/or overcooling, the manager 105 may control the air valve 421 that optionally directs cooled air from vehicle air conditioner 101. The air valve 421 may direct the cooled air toward the passenger compartment and/or toward another space, for example another compartment vehicle and/or the space outside the vehicle. Optionally, the air valve diverts 421 the air flow toward a system that transfers cool air to air conditioned suits of the passengers, for example air-cooled vest, air cooled overall, and/or air cooled CBRN (NBC) overall. Optionally, the air valve 421 placed in a T-junction of a system of air tubes that conducts the air from the vehicle air conditioner 101. One side of the T-junction leads toward the passenger compartment and the other side leads toward outside the vehicle and/or toward another compartment and/or cooling system. The air valve 421 may be any directional control valve. Optionally, the air valve 421 directs the cool air toward a cooling system that is sized and shaped to cool the water container 104. In such an embodiment, the cold air may be circulated in one or more pipes that circumvent the water container 104. The cooled air reduces and/or maintains the temperature of the treated water in a relatively low temperature. Optionally, the cooled air is used for cooling one of the cells in the water container 104. In such a manner, the water container 104 is used for providing water in different temperatures.

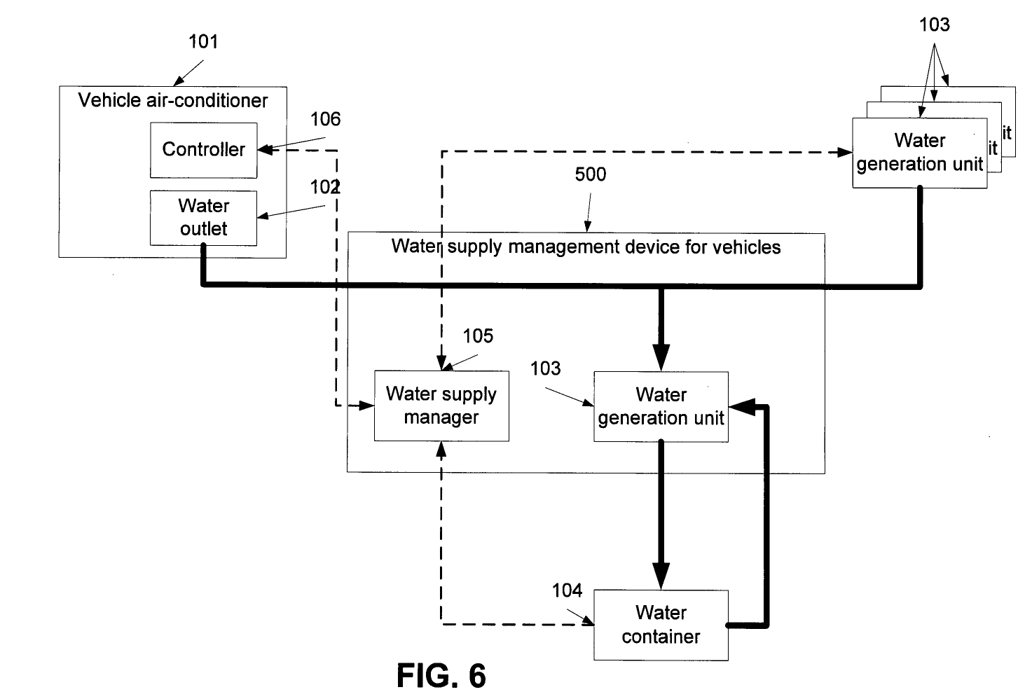

Reference is now made to FIG. 6, which is a schematic illustration of a water treatment device 500 of managing an operation of a vehicle air conditioner 101 and one or more additional water sources, according to some embodiments of the present invention. The water treatment device 500 is similar to water management device 100 depicted in FIG. 1; however in FIG. 5 the water treatment device 500 is connected via one or more water conducting tubes to one or more water generation unit 103. Optionally, each water generation unit 103 is defined as described below with reference to FIG. 8-13 and/or in Israeli Patent Application No. 200680, filed on Sep. 1, 2009 which is incorporated herein by reference. For example, one or more of the water generation units uses a dehumidifying unit based on a desiccant wheel, one or more condensers, one or more evaporators, a compressor, and/or any other unit that allows dehumidifying air. As described above, the water treatment device 500 treats water generated as a product of the operation of a vehicle air conditioner, as shown at 101. In order to provide treated water when the vehicle air conditioner 101 is inoperative and/or to increase the amount of treated water which are generated by the device, for example when the vehicle air conditioner does not generate sufficient water, one or more water generation units are connected to the device 105. The one or more water generation water may be external, optionally independent, units. The one or more water generation unit 107 may be integral units of the water treatment device 500.

In such embodiments, the manager 105 is electrically connected, wirelessly or with wires, to the controller of the one or more water generation unit 103 and/or replaces the controller of the one or more water generation unit 103. Similarly to the described above, the manager 105 may control the one or more water generation unit 103 according to water consumption, water generation status, water resources, and/or according to the operation of the vehicle air conditioner 101.

According to some embodiments of the present invention, the water generation unit(s) 107 and the vehicle air conditioner 101 shares units, such as the dehumidifying unit and/or power sources. In such an embodiment, the water generation unit(s) 107 and the vehicle air conditioner 101 may be alternately operated, according to the operator selection and/or measurements, such as temperature, humidity level, amount of water in the water container 104 and the like.

Reference is now made to FIG. 9A, which is an exemplary arrangement in which two radiators are interchangeably used condensers and/or evaporators, according to some embodiments of the present embodiment.

In a first arrangement, for example when the air conditioner is in a cooling mode, a first radiator 72, which is optionally external to the air conditioner, is used as a condenser and a second radiator 71, which is optionally an internal unit of the air conditioner, is used as an evaporator. In such an embodiment, water is collected by water collection tray 73.
In the second arrangement, for example when the air conditioner is in a heating mode, the second radiator 71 acts as a condenser and the first radiator 72 acts as an evaporator. In such an embodiment, water is collected by water collection tray 74. Water collected at tray 73 is drained via drainage tubes 75, 76 into a water collection buffer container 77. If possible water is moved by gravitation and/or a pump.

The arrangement depicted in FIG. 9A allows collecting water produced from an operation of the vehicle air container 101 in a heating mode and in a cooling mode.

Reference is now made to FIG. 8, which is a schematic illustration of a water generation unit, referred to herein as vehicle integrable device 1100, for producing water from air, such as ambient air, according to some embodiments of the present invention. This water generation unit 1100 may be part of the water management device 100 which is described above, for example in FIG. 8 a standalone unit and/or to other units as described below. Optionally, the water outlet 1104 is connected to a water container 1109, optionally in a detachable manner. In such an embodiment, the condensed water vapor is accumulated in the water container 1109. Optionally, the water container 1109 has a faucet that is connected thereto and/or one or more conducting elements, such as tubes, for conducting the accumulated water toward a faucet in and/or on the vehicle.

The vehicle integrable device 1100 includes a dehumidifying unit 1105 for condensing water vapor from air that is drawn therethrough. The dehumidifying unit 1105 has an air inlet 1101 from which the ambient air is drawn, an air outlet 1103 for extracting dehumidified air, and optionally a water outlet 1104 for extracting condensed water vapor. The housing 1130 is designed to be mounted in a vehicle, which is optionally an AFV, such as a tank, an armored personnel carrier, a small four-wheel-drive military vehicle, and an all-terrain vehicle. The housing 1130 is designed to absorb shocks, for example by using shock absorbers as described below and hardened to protect against wear, extreme temperature, chemicals, small arms fire and grenades. Optionally, a layer of an alloy, such as stainless steel alloy, is used for hardening the housing. Optionally, some or all of the passages, in which the drawn air pass, are coated with a protective layer, such as a polymeric layer. In such a manner, the water vapor is not exposed to metal, gases, and/or other toxic materials.

The vehicle integrable device 1100 is powered by a power source of the vehicle to which it is integrated, for example as described below, such as the battery and/or alternator. Optionally, the power source provides an AC current voltage in between 90 and 480 volts between 50 and 60 hertz or any intermediate value and/or a DC current voltage between 12 and 150 volts. Optionally, the vehicle integrable device 1100 runs at 400 hertz. In such a manner, the power supplies are smaller and lighter. This benefit is important as the space in the vehicle is limited and it is imperative to minimize weight in order to maximize performance. Optionally, the vehicle integrable device 1100 is connected to the power source via a commonly used military power connection, a vehicle battery, a designated battery or any combination thereof. Optionally, the vehicle integrable device 1100 comprises an alternator or any other power convertor that is connected to the engine's crankshaft. In such an embodiment, the power generated by the engine is directly converted to facilitate the dehumidification of water vapor.

Optionally, the dehumidifying unit 1105 is controlled by a controller 1107, such as a microcontroller or microprocessor. The controller is optionally connected to the aforementioned MMI and/or to MMI 1108, for example a keypad and/or a display, for allowing the use to operate the vehicle integrable device 1100 and/or to display the operational mode of the vehicle integrable device 1100 and/or the estimated water production thereof. Optionally, the MMI is a remote control that communicates with the controller using a wireless interface, such as wireless local area network (WLAN) interface, such as Wi-Fi™ interface and Bluetooth™ interface and/or a wired connection, such as a coaxial cable connection. The MMI 1108 optionally includes a display, such as a liquid crystal display (LCD) that allows presenting data pertaining to the air condensing process and/or gallons or liters that the unit produce and/or relative data like temperature and humidity and/or electrical consumption and/or CBRN (NBC) alerting and/or user alerting like parts failure and service requirements and/or water parameters like ORP and/or TDS and/or PH level and/or more parameters that give indication of the water condition In such an embodiment, the MMI 1108 may be attached to the dashboard of the vehicle and/or to any other accessible location in the passenger compartment.

According to some embodiments of the present invention, the vehicle integrable device 1100 utilizes air pressure which is generated by one or more of the units of the vehicle. Optionally, the condenser 1154 is directly connected to the air pressure system of the vehicle.

In such a manner, less electric power is needed for the water production process. Optionally, the controller 1107 controls one or more valves which regulate the air pressure which is received from the vehicle units. Optionally, the controller is connected to one or more sensors that allow evaluating the air pressure which is available for powering the condenser.

Optionally, the dehumidifying unit 1105 uses the cooling system of the vehicle. In such an embodiment, the compressor, the condenser, and/or the evaporator of the cooling system are controlled by the dehumidifying unit 1105.

Optionally, the components of the cooling system are adapted for water production. For example, the passages may be coated with a polymer and/or any other material that isolates the water vapor and/or the generated water from metals, gas, and/or other toxic materials. As further described below, the produced water may be treated by a cleaning unit, such as a reverse osmosis unit, and/or enriched various agents so as to facilitate the drinking thereof.

Additionally or alternatively, the condensed water vapor, which is generated by the cooling system of the vehicle, is conducted toward the water container 1109. In such an embodiment, the activation and/or deactivation of the vehicle integrable device 1100 may depend on the amount of water produced as an outcome of the operation of the cooling system.

Reference is now also made to FIG. 9A which is a schematic illustration of an exemplary dehumidifying unit 1105, according to some embodiments of the present invention. It should be noted that other dehumidifying units may be used. The dehumidifying unit 1105 has an air inlet 1150 for facilitating the passage of air therethrough. The air is motivated by an air drawing unit, such as a fan 1153. The motivated air from the air inlet 1150 passes via a hot coil condenser 1154, a heat element 1155, a desiccant wheel 1156 that is rotated by a motor, and a cold coil evaporator 1158. In use, the hot coil condenser 1154 and the heat element 1155 warm the air. The desiccant wheel 1156 turns, the desiccant passes alternately through the incoming air where the water vapor are adsorbed and through a regenerating zone where the desiccant is dried and the adsorbed water vapor are carried through a drain toward the water container 1109. As long as the wheel rotates and the air flow therethrough, the adsorbent process continues.

The cold coil evaporator 1158 cools the air that is than drawn from the dehumidifying unit 1105, towards the air outlet 1103. The cold coil evaporator 1158 condenses moisture which is discharged from the desiccant wheel 1156 on the outside of the coils and is carries it through a drain toward the water container 1109.

Optionally, the suction that is applied by the fan 1153 is adjusted according to the air passability level of the filtering unit 1106. If the air passability level of the filters is low, for example as an outcome of a blockage, dirt, and/or trapped particles, the suction increases. If the air passability level of the filters is high, the suction decreases. Optionally, the cleaning unit is activated according to an estimation of the air passability level. Optionally, the air passability level is evaluated by measuring the air flow in response to the pressure applied by the fan 1153.

Optionally, an additional fan 1160 is used for drawing air from another inlet 1159 which is optionally connected to another space. For example, while one of the air inlets 1150, 1159 is connected, for example via an air duct, to the passenger comportment of the vehicle, the other inlet 1150, 1159 is connected, for example via another air duct, to an aperture to an ambient air that surrounds the vehicle. Optionally, the fans are operated simultaneously and/or alternatively, optionally according to hygrometers which are located in the space from which the air is drawn. Optionally, the cold coil evaporator 1158 and the hot condenser coil 1154 are separately circulated with air, for example each by a separate fan.

According to some embodiments of the present invention, a pre-cooling device is used for cooling the air which is blown in-front of the evaporator 1158, which may be referred to as cooling coils. In such an embodiment, the humid air from which water are extracted is cooled down before and/or during the circulation thereof around the cooling coils. This increases the throughput of the dehumidifying unit 1105. Optionally, the pre cooling device comprising an air to air heat exchanger, such as a plate or a rotary wheel, which is placed to be in contact with humid air conducted toward the evaporator 1158 and one or more ducts, optionally semi circular, which are placed to conduct air that has been circulated around the cooling coils toward the heat exchanger. The cold dry air from the evaporator 1158 allows the heat exchanger to cool down the humid air that is conducted toward the evaporator 1158 by heat transfer. FIG. 9B schematically depicts such an arrangement when air to air exchanger plate 1999 is used to reduce temperature and semi circular duct 1998 is used to cycle cold air toward the air exchanger plate 1999. Optionally, as shown at FIG. 9B, the air is conducted in front of the evaporator 1158 twice. FIG. 9C schematically depicts such an arrangement when a rotary wheel 1997 is used as a heat exchanger for cooling the air that is conducted toward the cooling coils. FIG. 9D is schematic illustration of a pre cooling arrangement where two heat exchangers are used, each mounted in proximity to opposing sides of the evaporator 1158. This arrangement may be used when two opposing inlets and outlets are used. FIG. 9E is schematic illustration of a fin based pre cooling arrangement. In this arrangement heat exchanger fins 2000 circulated the air a plurality of times in front of the evaporator 1158 in a plurality of conduits 2001. Valves 2002 may be used to direct the dry air from one conduit to another.

Optionally, a pre cooling arrangement includes a liquid based heat exchanger 2010 for liquid-to-liquid heat transfer. In this embodiment, the heat exchanger surrounds the evaporator 1158, for example as shown at FIGS. 9F and 9G. In these figures, the left portion 2011 of the liquid based heat exchanger is cooled down by the air that passes in front of the evaporator 1158. This allows reducing the temperature of the right portion 2012 of the liquid based heat exchanger by liquid-to-liquid heat transfer. The reduction of the temperature at the right portion 2012 cools down the air before it is conducted in front of the evaporator 1158. A pump 2013 is used to circulate the liquid in the liquid based heat exchanger 2010.

According to some embodiments of the present invention, the cooled air which is passed in front of the evaporator 1158 is conducted toward the condenser 1154, reducing the temperature of the air around it. In such a manner, the temperature of the air that surrounds the condenser 1154 is reduced and therefore the throughput of the condenser 1154 is increased. Optionally, the condenser 1154 is divided to a pre cooled section and a heating section. The air from the evaporator 1158 is drawn to cool down the pre cooled section and ambient air is drawn to cool down the heat section. In such a manner, the temperature of the coolant in the condenser 1154 is reduced when it passes from the heating section to the pre cooling section, before being conducted toward the evaporator. In such a manner, the efficiency of the condenser-evaporator cycle is increased.

According to some embodiments of the present invention, one or more a compressor engine, for example 1162 and the blower which draws air therearound. The controller 1107 operates the compressor and blower, for example by voltage supply. At a standard mode, the compressor and blower operate at a capacity which is adapted to the weather conditions, for example in a partial capacity. For example, when the ambient temperature is 25° C. and the RH is 55%, the compressor cooling capacity is 2700 Watt and the blower is operated at an air delivery of about 350 CM/H with water production of about 1.0 Lit/Hr. At a maximum water production mode, the compressor and blower may be operate at a higher capacity. For example, when the ambient temperature is 25° C. and the RH is 55%, the cooling capacity of the compressor is 4900 Watts and the blower operates in an air delivery capacity of 600 CM/H and water production: of about 1.6 Lit/Hr.

According to some embodiments of the present invention, the vehicle integrable device 1100 comprises an air filtering unit 1106 for filtering the air that is drawn via the air inlet 1101. Optionally, the air filtering unit 1106 is a high efficiency particulate air (HEPA) filter that remove at least 99.97% of airborne and/or aerosol particles 0.3 micrometers (μm) in diameter.

According to some embodiments of the present invention, the vehicle integrable device 1100 is cooled by a gas based cooling system. Optionally, the cooling gas is CO₂.

Reference is now also made to FIG. 10, which is a sectional schematic illustration of the vehicle integrable device 1100 with a HEPA air filtering unit 1106, according to some embodiments of the present invention. The vehicle integrable device 1100 is as described in FIG. 8 and having the hot coil condenser 1154, the cold coil evaporator 1158, the fan 1153, and the water container 1109, are as described above. FIG. 10 further depicts a number of filters 1204-1206 of the air filtering unit 1106. In use, the filters 1204-1206 are used for filtering the air that is drawn via the air inlet 1101. As depicted in FIG. 10, the air filtering unit 1106 optionally has a chamber 1201 for placing one or more filters. The chamber 1201 having an aperture 1202, optionally closable with a cover 1203 with a handle 1209, for loading filters into the chamber 1201. In the exemplary embodiment depicted in FIG. 10, one or more micro fiber filter 1204, an activated carbon filter 1205, and a charcoal dust filter 1206 are loaded in the chamber 201. Such a combination may be collectively referred to as a chemical, biological, radiological, and Nuclear (CBRN) filter and/or a nuclear, biological, chemical (NBC) filter. For clarity, any combination of filters or other NBC (CBRN) cleaning technologies may be inserted into the chamber. Optionally, the chamber 1201 is sealed with a layer of silicon sealing and/or CBRN rubber, such as butyl rubber, Polylsoprene rubber and/or Neoprene rubber.

Additionally or alternatively, the air filtering unit 1106 is modular. In such an embodiment, the chamber 1201 allows using filters 1204-1206 in a modular manner. In such an embodiment, any combination of filters may be used. In use, the operator may replace the filters according to changes in the threats and/or environmental conditions. For example, is a certain chemical contamination may be found in the space that surrounds the vehicle, the operator may add a chemical filter. Else, the use will remove the chemical filter in order to prolong filter life.

Additionally or alternatively, the air filtering unit 1106 has a plurality of air passages and one or more valves for directing air via one or more selected air passages from a selected group from the plurality of air passages. Optionally, the one or more valves are controlled by the controller 1107. In such an embodiment, different air passages may be selected for drawing ambient air in different situations. For example, while one pass draws air via dirt filters, others draw the ambient air via CBRN (NBC) filters. Optionally, the alternative air passages are arranged to allow bypassing each one of a plurality of filters separately and/or simultaneously. For example, the air may be separately or jointly drawn via a micro fiber filter, an activated carbon filter, and a charcoal dust filter. Optionally, the air passages are manually selected according to the MMI 1108 outputs. Optionally, the air passages are automatically selected according to the controller 1107, optionally according to the reading of related sensors, such as CBRN (NBC) sensors and/or CBRN (NBC) modes.

The filter replacement is facilitated by opening the cover 1203, for example using the handle 1209. Optionally, the opening of the cover automatically deactivate the operation of the vehicle integrable device 1100 and/or triggers a standby mode. Optionally, the deactivation is performed when a button that is pressed by the cover 1203 is released. In such a manner, to water production is stopped and a contamination by unfiltered air is avoided.

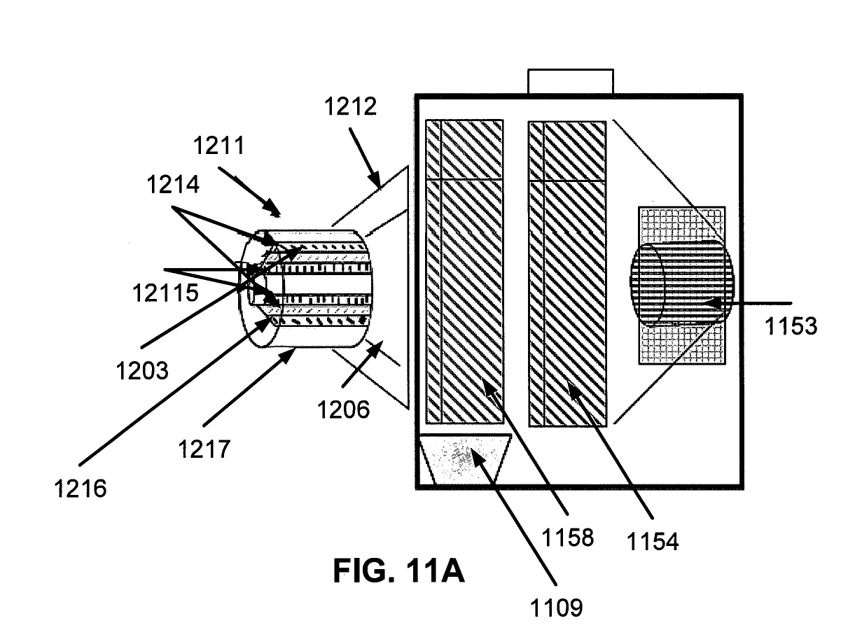

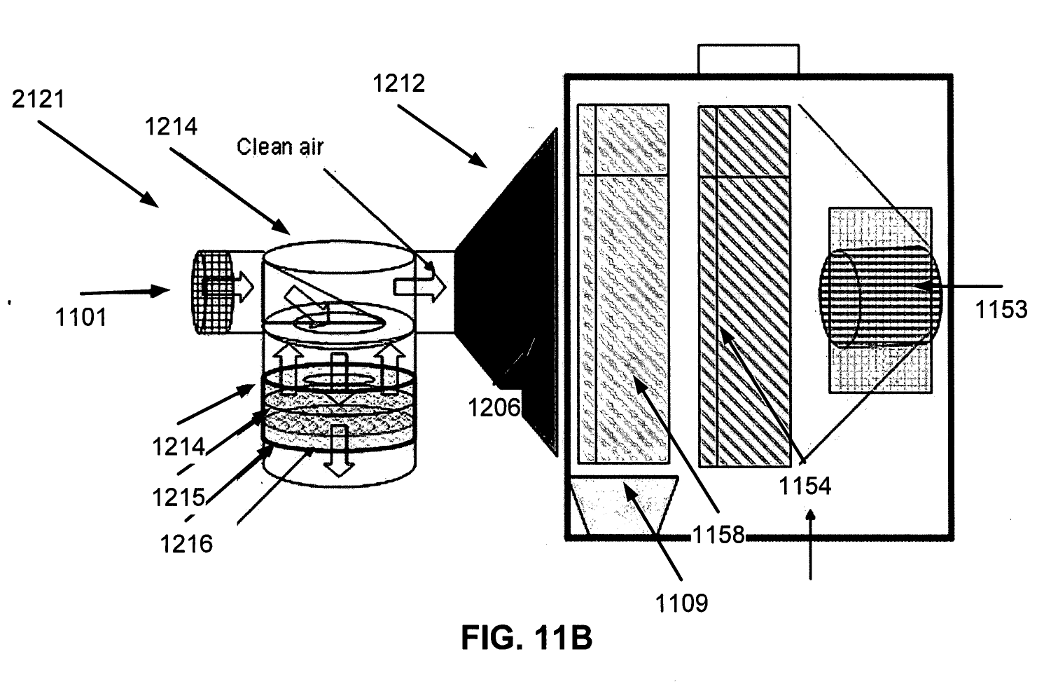

Reference is also made to FIG. 11A, which is a sectional schematic illustration of the vehicle integrable device 1100 with a canister based filtering unit 1211, according to some embodiments of the present invention. Reference is also made to FIG. 11B, in which the canister based filtering unit 1211 is perpendicular to the air inlet 1101, facilitating the removal of particles having a relatively wide diameter, according to some embodiments of the present invention.

The canister based filtering unit 1211 includes substantially concentric cylindrical filters 1214-1216, optionally a micro fiber filter 1215 an activated carbon filter 1214, and a charcoal dust filter 1216. The substantially concentric cylindrical filters 1214-1216 are connected to the housing 1130 via a conical support 1217 that encircles the canister based filtering unit 1211, optionally made from silicon and/or CBRN (NBC) rubber. Optionally, the concentric cylindrical filters 1214-1216 are provided as a single replaceable filter unit that is placed in the cylindrical chamber of the filtering unit 1211. Optionally, the concentric cylindrical filters 1214-1216 are connected to the inlet of the dehumidifying unit 1105 via a conical element 1212, optionally made of a layer of silicon sealing and/or CBRN (NBC) rubber, such as butyl rubber, PolyIsoprene rubber and/or Neoprene rubber.

Optionally, in use, the air filtering unit 1106, 1211 removes toxic chemicals and biological warfare agents in a gaseous and/or aerosol form from the air passing via the air inlet 1101. Optionally, the micro fiber filter 1204, 1215 filters polluted air that passes therethrough, for example impurities, such as solid and liquid, optionally radioactive, inorganic, organic particles and/or germs. Optionally, the micro fiber filter 1204, 1215 is as defined in MIL-F-51079 specification that is incorporated herein by reference. Optionally, the activated carbon filter 1205, 1214 adsorbs toxic agents in gaseous and/or aerosol form by physical and/or chemical actions and reactions. low mass molarity, such as certain cyanides or phosgenes. may be optionally removed by adding particles such as Copper(I) oxide, Silver salts, and/or a certain Chromium compounds of oxidation .to the activated carbon filter 1205, 1214, optionally as a solution.

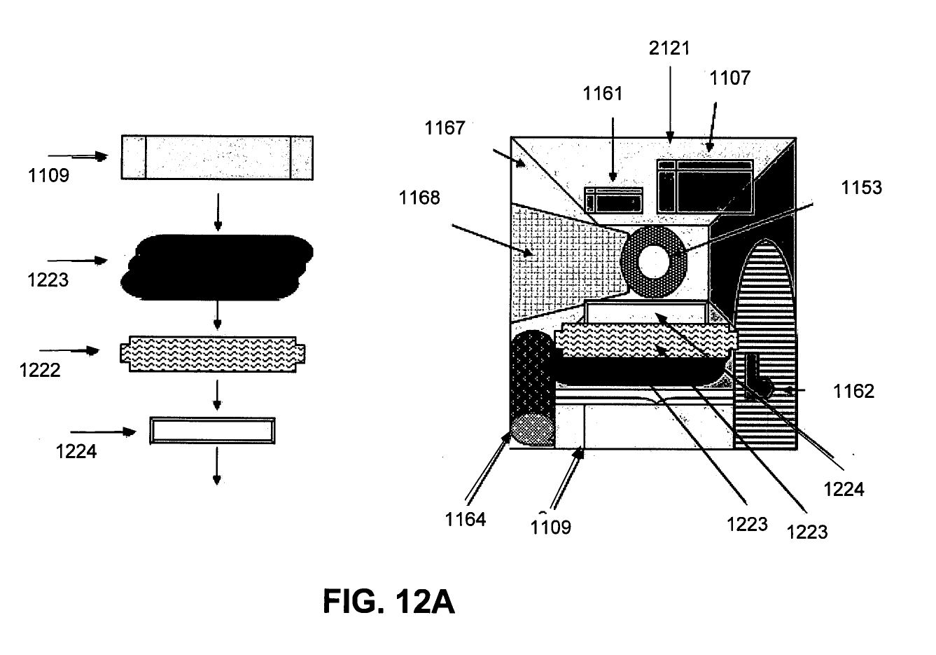

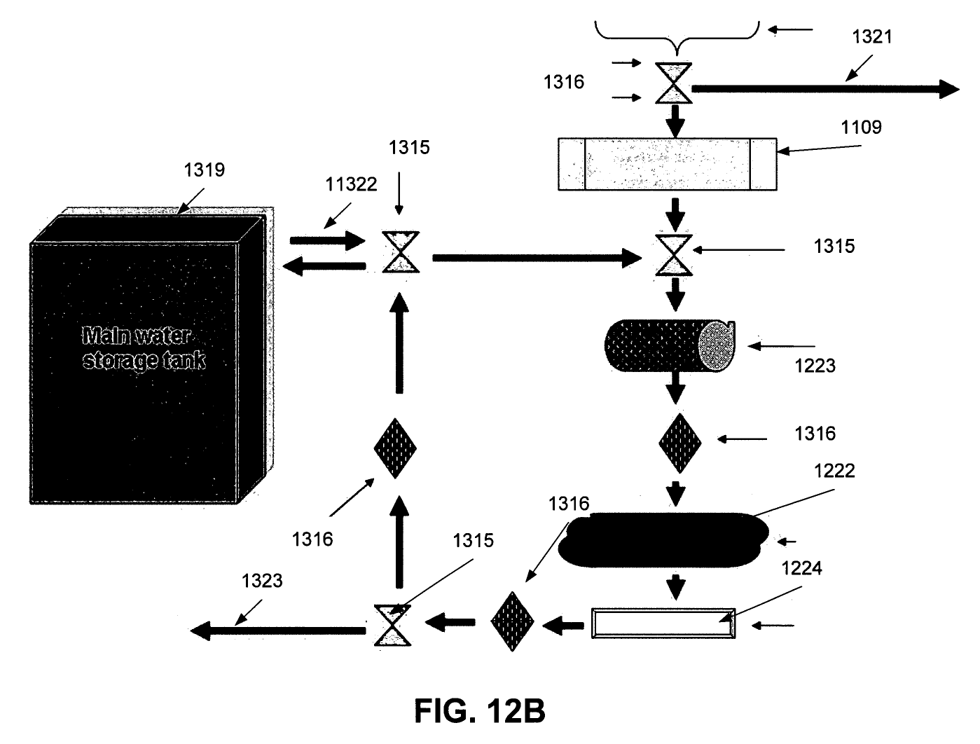

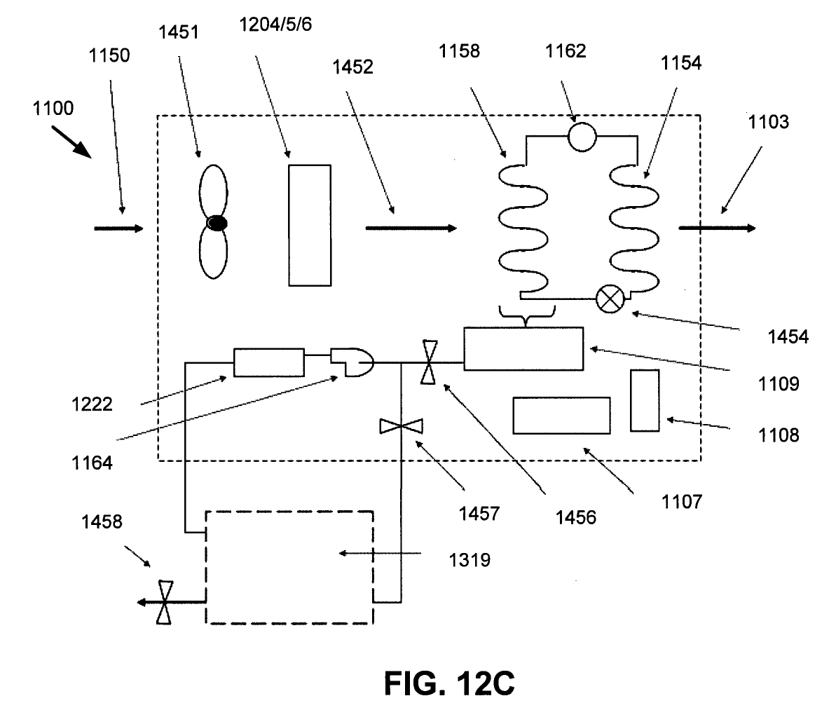

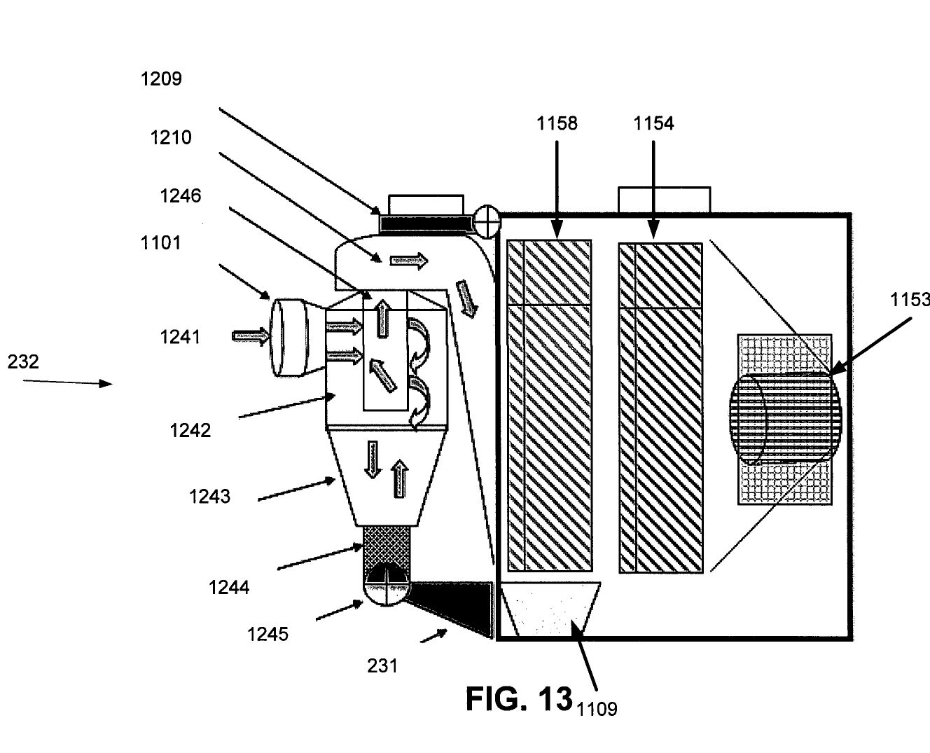

As depicted in FIG. 11B, particles which are drawn via the inlet passes via a U shaped and/or a V shaped passage. In such a manner, large particles may be filtered. Additionally or alternatively, the vehicle integrable device 1100 includes a water filter for filtering the condensed water vapor, before, after, and/or during the accumulation thereof in the water container 1109. Reference is now also made to FIG. 12A, which is a rear sectional schematic illustration of the vehicle integrable device 1100 with a water filtering unit 1221 of reverse osmosis filtering and set of water filtering components 1222-1223 of the water filtering unit 1221, according to some embodiments of the present invention. FIG. 12A depicts a rear view of the components of the vehicle integrable device 1100. In particular, the rear view includes the back of the controller 1107, an electronic box with the controller of the UV lamp 1161, a compressor engine 1162 that compresses moist air into the dehumidifying unit 1105, the aforementioned fan 1153, and the water pump 1164 of the water filtering unit.

Optionally, in use, the water filtering unit 1221 draws the water from water container 1109 towards a membrane assembly 1222 having a pressure vessel that presses the water against the thin film composite membrane, such as a spiral-wound membrane and a hollow-fiber membrane. The thin film composite membrane traps pollutants and microorganisms from the pressed water. Optionally, the thin film composite membrane is a microfiltration (MF) membrane for rejecting suspended particles and high molecular weight compounds, an ultrafiltration (UF) membrane, and/or a nanofiltration (NF) membrane for rejecting low molecular weight compounds and ions. MF membranes reject. Optionally, the membrane is made from cellulose acetate (CA) and/or polyamide thin film composite (TFC). These may come in spiral, tubular hollow fibers, plate and frame fibers, or proprietary configurations. Optionally, the pressing via the membrane removes particles having a diameter of more than 0.1 mm. Optionally, the pressing via the membrane purifies salt water and water contaminated with CBRN (NBC) agents from the water.

Optionally, the water filtering unit 1221 draws the water via one or more sediment filters 1223, such as fiber rolls or wattles, each configured for trapping particles having a diameter over a certain threshold before arriving at the membrane assembly 1222. Optionally, the first sediment filter is used for capturing particles having a diameter of more than 5 mm and a second sediment filter is used for capturing particles having a diameter of more than 3 mm and so on and so fourth. Optionally, the diameter of the captured particles is determined according to the size of the pores of the sediment filters. Optionally, the water filtering unit 1221 removes filtered particles via a drain.

Additionally or alternatively, the water filtering unit 1221 further draws the water via an activated carbon filter 1223 that traps organic chemicals, such as herbicides and pesticides, and may also remove objectionable tastes and odors, before arriving at the membrane assembly 1222.

Additionally or alternatively, the water filtering unit 1221 further includes a carbon filter (not shown) that is placed to trap chemicals which are not removed by the RO membrane.

Additionally or alternatively, the water filtering unit 1221 draws the water in front of further includes a ultra-violet lamp 1224 for disinfecting microbes which are not removed by the RO membrane. Optionally, the UV illumination is concentrated in the 254 nanometers (nm) region so as to allow removing some or all of the bacteria and/or viruses, such as e-coli, cholera, typhoid, anthrax and polio in the water. Optionally, the ultra-violet lamp 1224 is designed to illuminate the water which is in the water container 1109.

According to some embodiments of the present invention, the water container 1109 receives water from one or more water sources which are located in and/or on the vehicle. In such an embodiment, the water container 1109 may be external to the vehicle integrable device 1100, for example the water container of a tank, an airplane, a train and the like.

Optionally, the aforementioned power monitoring module activates and/or deactivates the vehicle integrable device 1100 according to the amount of water in the external water container.

Optionally, the water in the water container 1109 is periodically, randomly, and/or continuously circulated via the water filtering unit 1221. Optionally, the water in the water container 1109 are circulated via the Water filtering unit 1221 according to the outputs of one or more water quality sensors, such as dissolved oxygen, pH, turbidity, temperature, and salinity sensors, passed via the water filtering unit 1221. In such an embodiment, a pump, such as a booster pump is used for circulating the water from the water container 1109 via the water filtering unit 1221.

Reference is now also made to FIG. 12C, which is a schematic illustration of elements used for cleaning water using water filtration and/or reverse osmosis, such as the accumulated water and/or water from additional sources, and an exemplary arrangement of the elements, according to some embodiments of the present invention. The elements are as depicted in FIG. 12A, however FIG. 12C depicts a number of valves 1315, such as a solenoid valves, which are used for directing the water during the cleaning process and a set of sensors for monitoring the water cleaning process. Optionally, the valves 1315 allow directing the water toward a main storage tank 1319, as shown at 1322, toward one or more sprinkles which are used to clean the dehumidifying unit 1105, as shown at 1323, for example as described below, and/or toward a drain, as shown at 1321.

It should be noted that the water cleaning by reverse osmosis allow filtering particles which have not been filtered or otherwise removed by the air filter. In such a manner, the CBRN (NBC) filtering ability of the vehicle integrable device 1100 is increased.

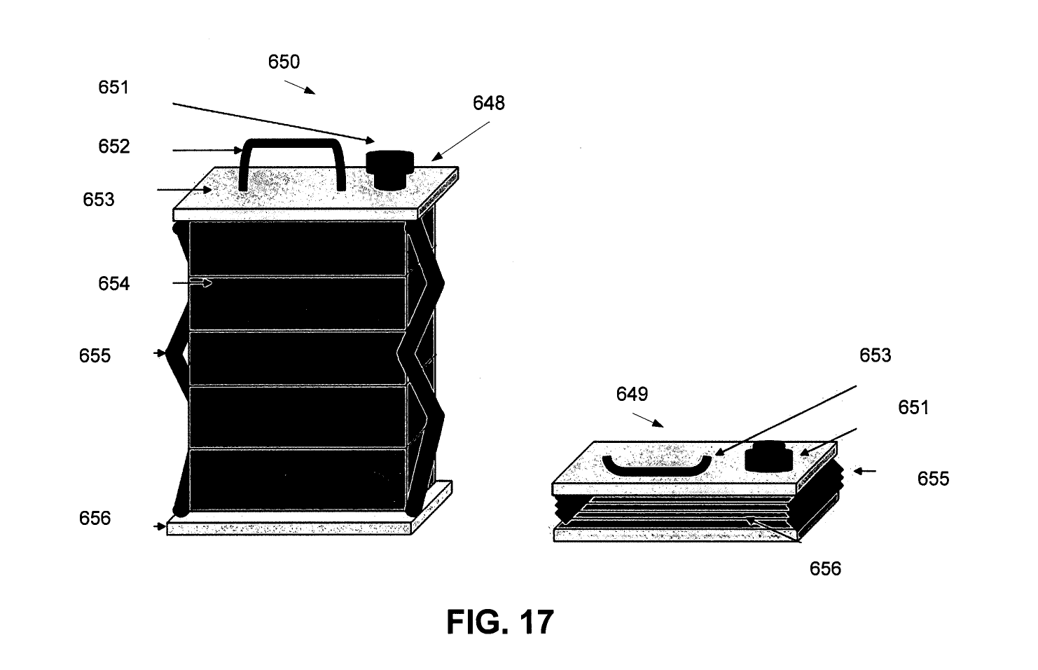

According to some embodiments of the present invention, the water container 1109 and/or the main water tank 1319, where available are detachable. In such an embodiment, the water container may be released from the system and used for providing water to the passengers of the vehicles and/or carried for other consumers, such as a platoon which is in proximity to the vehicle, another vehicle, and/or carried for other usages. Optionally, the vehicle includes a number of detachable water containers. In such an embodiment, each time a certain water container is filled with accumulated water; it is replaced with another detachable water container. In such a manner, water may be accumulated when the water production conditions, namely the temperature, the power generation level, the humidity level and/or any combination thereof are above a certain level or optimal. Optionally, one or more of the detachable water container 1109 has one or more adjustable dimensions. For example, FIG. 17 depicts a foldable water container 650 in a folded 649 and unfolded 648 states. Optionally, the foldable water container 650 has foldable arms 655 that support the structure of a foldable container 654 between two plates 653, 656. In such an embodiment the foldable water container 650 may have a number of different folding states so as to adjust the height of the foldable water container 650 according to the amount of water it accumulates. Optionally, the amount if water determines that height of the foldable water container 650 as the pressure of the water pushes the two plates 653, 656 away from one another. Optionally, the foldable water container 650 has a cap 651 which may be adjusted in a designated water outlet and/or a handle, 652, optionally foldable. Optionally, the water container 1109 is divided to a number of sub-containers, optionally detachable. In such a manner, sub-containers may be provided to different consumers. Furthermore, a sub-container may be detached while others are filled.

Reference is now made to FIG. 12C, which is a schematic illustration of a vehicle integrable device that combines both an air filtering system and a water filtering system, according to some embodiments of the present invention. Most of the components of the depicted vehicle integrable device 1100 are depicted and described above. However, in FIG. 12C, a blower 1451 is placed in proximity to the air filters 1204-1206. In addition, the cold evaporator coil 1158 and the hot condenser 1154 are connected to an expansion valve that controls the flow of the refrigerant from the refrigerant compressor 1162. The water vapor which are produced during the dehumidifying process are gather at the water container 1109 and forwarded, optionally when the controller 1107 instructs a suitable valve, such as shown at 1456, toward the water filters 1222. The water are drawn by the water pump 1164 and optionally gathered at a main water container 1319. Water from the main water container 1319 is optionally poured when a respective valve is opened, as shown at 1458. The opening of and/or the closing of a designated valve 1457 between the main water container 1319 and a junction that splits between the water container 1109 and the water pump 1164 allows cycling water from the main water container 1319 via the filters 1222.

According to some embodiments of the present invention, the vehicle integrable device 1100 is designed to condense water vapor from air with relatively high percentage of dust particles, for example surrounding air during a dust storm and/or a sand storm. In such an embodiment, one or more filters are used for trapping dust and/or sand grains. For example, reference is now also made to FIG. 13, which is a sectional schematic illustration of the vehicle integrable device 1100 with a debris filter 231, such as a cyclonic filter 231, for separating unwanted debris from an air with relatively high percentage of dust particles that is drawn via the air inlet 1101, according to some embodiments of the present invention. The components of the vehicle integrable device 1100 are as described above in relation to FIG. 9A. FIG. 13 further depicts the components of the cyclonic filter 231. In particular, the filtering unit 231 includes a cyclonic separator that draws dirty air 1241, via the air inlet 1101 into cyclone body 1242 having a structure that allows utilizing centrifugal forces and/or low pressure caused by spinning motion to separate materials of differing density, size and shape, for example as known in the art. Particles in the air are forced to the outside of the cyclone body 1242 by inertia. Due to surface effects, the air flow at the wall is slower. The slow air layer is incapable of suspending many of the particles, so these particles, for example dirt particles, drop to the bottom of the cyclonic filter 231 and settles out from the air stream into a conical section 1243 that ends in a dirt bin 1244 which is optionally connected to a dirt deposable unit 1245 that periodically, randomly, and/or upon command cleans it. The cleaned air flow is drawn via a gas outlet 1246 that is connected to the aforementioned dehumidifying unit 1105.

According to some embodiments of the present invention, the components of the vehicle integrable device 1100 are placed in an external housing (not shown) that is designed to be attached to the vehicle from the outside and an internal housing (not shown) that is designed to be placed in the vehicle. In such an embodiment, the cold coil evaporator 1158 and the water container 1109 are mounted inside the internal housing and the other components at the external housing of the vehicle. The two housing are connected to one another via one or more refrigerant tubes and one or more electrical cables.

Additionally or alternatively, the air inlet 1101 in connected to receive air via one or more air filters of the vehicle. Optionally, the air inlet 1101 is connected to the outlet of the ventilation systems of the vehicle. In such a manner, the received air is filtered before being dehumidified by the vehicle integrable device 1100. Optionally, the air inlet 1101 is placed to receive air from the passenger comportment of the vehicle. In such a manner moisture emitted from the bodies of the passengers is filtered and condensed to water. Optionally, the air inlet 1101 is connected to the hot air outlet of the engine.

Additionally or alternatively, the air outlet 1103 is connected to one or more of the systems of the vehicle, for example to the suction valve of the engine and/or to the ventilation apertures of the passenger compartment.

According to some embodiments of the present invention, one or more oxidizing materials are added to the accumulated water and/or drawn air. In such a manner, the air and/or water are sterilized.

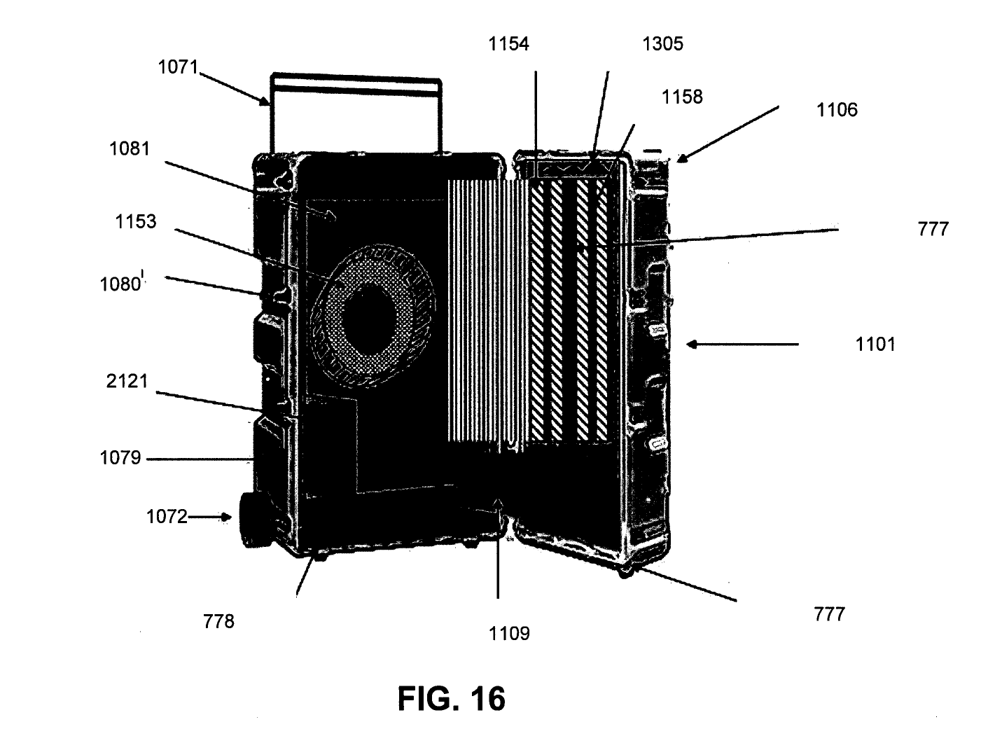

According to some embodiments of the present invention, the vehicle integrable device 1100 includes one or more shock absorbers, for example as depicted in numeral 778 of FIG. 16, that reduce the effect of vibration of the vehicle integrable device 1100 during the operation of the vehicle.

Optionally, the one or more shock absorbers include one or more rubber straps, pneumatic shock absorbers, hydraulic shock absorbers, springs, wire shock absorbers, such as wire a shock absorber, which include metal wires, synthetic resin wires, and/or stainless steel wire, and/or leafs, such as one or more strips of metal plastic and/or carbon. The shock absorbers may be connected to the housing that supports the components of the vehicle integrable device 1100 and/or directly to any of the components.

As described above, the vehicle integrable device 1100 is powered by the vehicle's battery and/or alternator. Optionally, the vehicle integrable device 1100 includes a power monitoring module for monitoring the voltage of the power provided by the battery and/or alternator. Optionally, if the voltage is below a certain threshold, the power monitoring module shuts the vehicle integrable device 1100 or changes its operational mode to standby.

Optionally, the vehicle integrable device 1100 includes a humidity sensor that monitors internal and/or ambient humidity. In such an embodiment, the output of the humidity sensor may be used for activating and/or deactivating the water production process of the vehicle integrable device 1100. Optionally, if the output indicates that the humidity is below a certain threshold, the vehicle integrable device 1100 shuts down or changes its operational mode to standby. Optionally, if the output indicates that the humidity is above a certain threshold, the vehicle integrable device 1100 is activated. Optionally, the humidity sensor is connected to a computing unit and/or integrated in a system on chip (SoC) which is connected to a presentation unit, such as a screen. In such an embodiment, the SoC or the computing unit may calculate the amount of water that may be generated per time and/or energy unit.

Optionally, the vehicle integrable device 1100 includes a power sensor that monitors, directly or indirectly, power that is available for water production, for example by measuring the torque of the crankshaft, the voltage of the battery, and/or the revolutions per minute (RPM) of the vehicle's engine. In such an embodiment, the output of the power sensor may be used for activating and/or deactivating and/or to increase or decrease the water production process of the vehicle integrable device 1100. Optionally, if the output indicates that the generated power is below a certain threshold, the vehicle integrable device 1100 shuts down or changes its operational mode to standby or economy mode. Optionally, if the output indicates that the power is above a certain threshold, the vehicle integrable device 1100 is activated. Optionally, the power sensor is connected to the aforementioned computing unit and/or integrated in a SoC that is connected to the aforementioned MMI 1108.

Optionally, the vehicle integrable device 1100 has a number of operational modes, each adapted to a different weather, a different humidity level, a different voltage supply, a requested water production amount, and/or a combination thereof and/or to filter different particles from the blow air and/or the condensed water vapor. In such an embodiment, the vehicle integrable device 1100 may have a variable turnout. For example, the vehicle integrable device 1100 employs one or more compressors, optionally multistage compressors and a means of modulating their capacity, automatically and/or manually, to match an instantaneous and/or predicted refrigeration demand. Optionally, this means includes an inverter that converts direct current from the vehicle into alternating current in variable speeds so as to control the amount of generated water and/or power consumption.

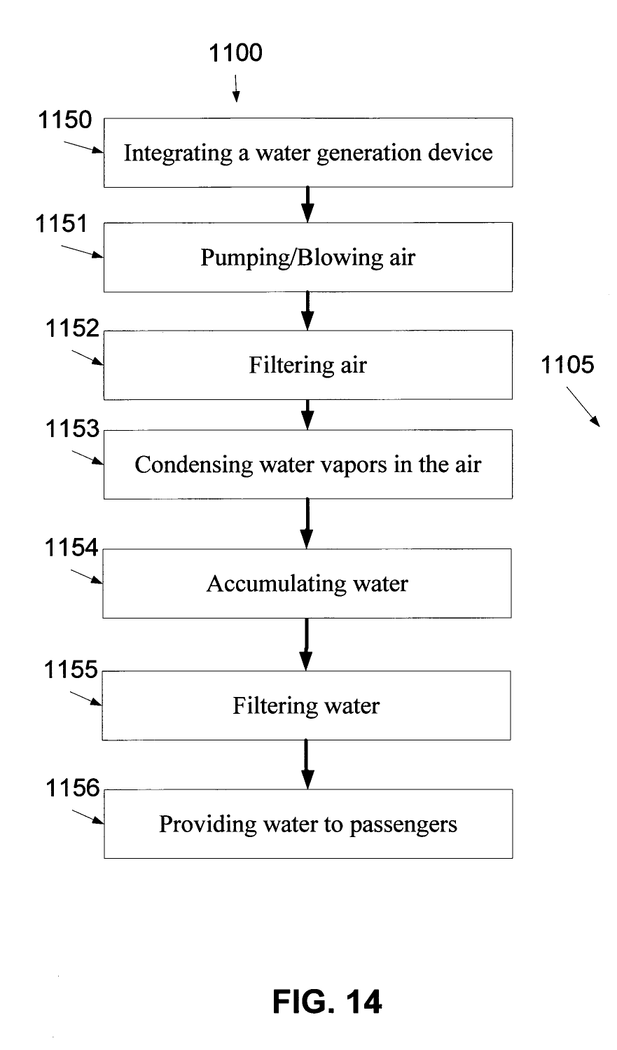

Reference is now also made to FIG. 14, which is a flowchart of a method of producing water from air in a vehicle, according to some embodiments of the present invention. First, as shown at 1550, a device, such as the vehicle integrable device 1100, is integrated into a vehicle. Optionally, the integration includes connecting the vehicle's power source to the vehicle integrable device 1100 so as to allow the powering of the water production, using the vehicle's ventilation system for drawing air via the vehicle integrable device 1100, using the vehicle's filters for filtering the air from which the water is generated, drawing moist air from the passenger comportment, using the water container of the vehicle, and/or any combination thereof.

Now, as shown at 1551, moist air is pumped and/or blown, for example via the air inlet 1101 toward the dehumidifying unit 1105. Optionally, the vehicle integrable device 1100 is automatically activated according to one or more weather measurements, for example temperature and/or humidity level. Additionally or alternatively, the vehicle integrable device 1100 may present activation and/or deactivation recommendations based on the one or more weather measurements, for example using the MMI 1108. The humidity level and the temperature are detected in the space from which the air is drawn, optionally according to the outputs of a hygrometer and/or a thermometer that interfaces with the controller 1107. The activation and/or recommendation may be computed according to each one of the measurements and/or a combination thereof.

Additionally or alternatively, the user may define, for example using the MMI 1108, the amount of energy that is about to be consumed for the water production, for example in watts and/or in fuel gallons. In use, the controller 1107, which optionally comprises a memory unit for storing a table detailing activation patterns and/or a set of conversion equations that adjust an activation pattern according to the user's input, adjust the water production process accordingly.

Then, as shown at 1552, the air is filtered, for example as described above. In such a manner, toxins, dust particles, different biomolecules, for example proteins and viruses, are filtered. Now, as shown at 1553, the water vapor in the filtered air is condensed, for example using the aforementioned dehumidifying unit 1105. For example, in the dehumidifying unit 1105 depicted in FIG. 10, the water vapor are condensed on the cold evaporator coil 1158, optionally similarly to the described above. The condensing allows accumulating condensed water vapor in the water container 1109, for example as shown at 1554 and similarly to the described above. Now, as shown at 1555, the condensed water may be filtered, for example using the water filtering unit 1221, optionally similarly to the described above. As shown at 1556, this allows providing water to one or more passengers of the vehicle.

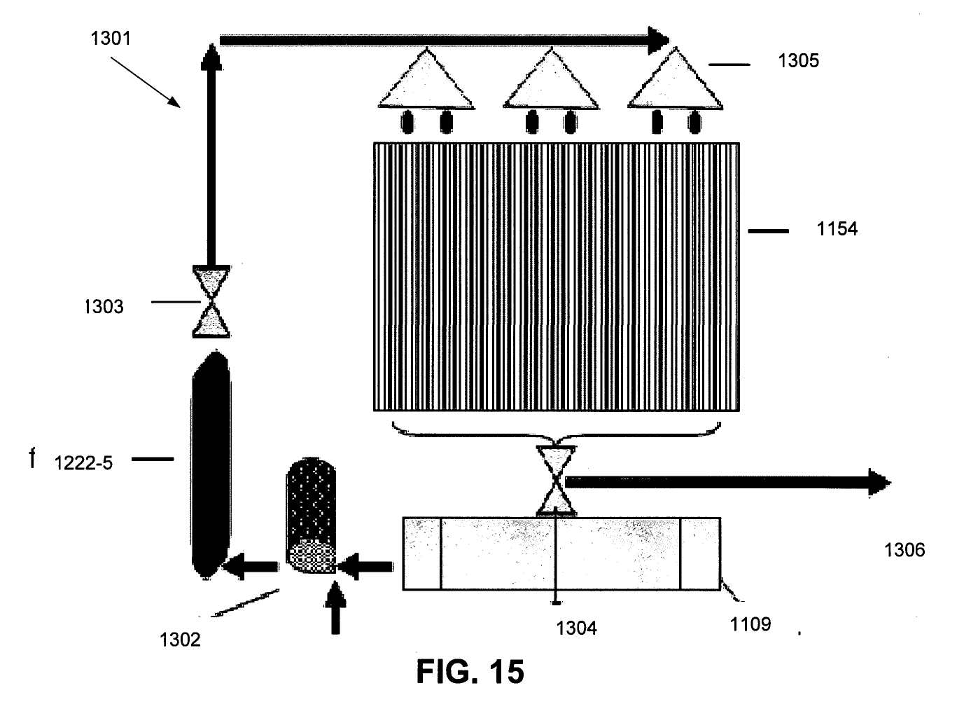

Reference is now made to FIG. 15, which is a schematic illustration of the components of a self cleaning unit 1301 that is used for cleaning one or more of the aforementioned evaporator, and/or condenser and/or other parts according to some embodiments of the present invention. Optionally, the self cleaning unit 1301 is integrated into the vehicle integrable device 1100 and connected to the controller 1107 thereof. In such an embodiment, the self cleaning unit 1301 may be activated manually by the aforementioned MMI 1107 and/or automatically from time to time, optionally according to a predefined schedule, and/or according to the amount of available water in the water container. Optionally, the water container 1109, or any other container, is used as a water source for the self cleaning unit 1301. The water container 1109 further includes a pump 1302, such as a booster pump, for blowing the water via one or more of the, optionally water filters 1222 and 1223 and/or via the condenser 1154 and/or evaporator, optionally by sprinklers 1305. Optionally, a valve, 1304 such as a solenoid valve, is used for extracting filtering water away from the vehicle integrable device 1100. Optionally, a valve, such as a solenoid valve 1303, is used for directing filtering water toward the sprinklers 1305. Optionally, the sprinklers 1305 may be designed to add sterilizing materials to the water. Optionally, the sprinklers 1305 create a steam which is used for sterilizing the surfaces of the cleaned elements. The filtering water may either be returned to the water container 1109, and/or extracted from the vehicle integrable device 1100 via a water outlet 1306.

According to some embodiments of the present invention, the water generation unit, for example the vehicle integrable device 1100, is mounted in a cart, such as a trolley, for example as shown in numeral 777 of FIG. 16. Optionally the casing 1079 of the vehicle integrable device 1100 is hardened, for example made of mil-spec rubber, such as Buna, Butyl, Nitrile, Neoprene, DuPont's Viton and Hypalon, EPDM, and/or a combination thereof. By using such a rubber, the casing provides sealing from CRBN (NBC) agents and/or particles. Optionally, the casing 1079 is locked using fast close knobs 80 and/or any other fasteners. In such an embodiment, the vehicle integrable device 1100 may be carried from one vehicle to another, for example using a telescopic handle 1071 and wheels 1072.

As depicted in FIG. 16 all many of the aforementioned components and units are housed in an interior space 81 of a single hardened casing 1079. This allows installing the vehicle integrable device 1100 in the vehicle without much effort and/or need to fixate each component and/or unit separately. The vehicle integrable device 1100 may be uninstalled without much effort as all the component and/or unit are connected to the vehicle as a single element.
According to some embodiments of the present invention, the noise of the vehicle integrable device 1100 is reduced by covering the casing with a layer of mineral wool, such as Rockwool. Such a layer may also improve the thermo isolation vehicle integrable device 1100.

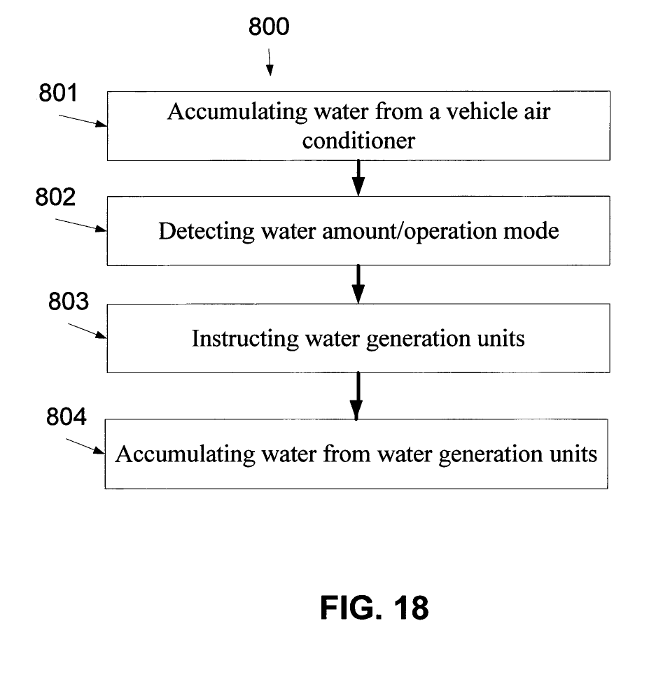

Reference is now also made to FIG. 18, which is a flowchart of a method 800 of controlling one or more water generation units, such as 107, according to water output and/or operation of a vehicle air conditioner, such as 101 according to some embodiments of the present invention. First, as shown at 801, water generated as a product of the vehicle air conditioner 101 is accumulated. Then, as shown at 802, a change in the amount of the accumulated water and/or a change in the operation mode of the vehicle air conditioner are detected. Now, as shown 803, one or more water generation units are operated according to the detected amount and/or the detected current operation mode. For example, if the vehicle air conditioner 101 generates limited amount of water and/or works in a mode having low water production, the manager 105 instructs the water generation unit 103 to increase their throughput. In another example, weather conditions, such as measured humidity level and/or temperature, allows estimating the water production level of the vehicle air conditioner 101. The manager 105 instructs the water generation unit 103 to increase and/or decrease their throughput according to the water production level of the vehicle air conditioner 101. As shown at 804, the water generated by the water generation unit 103, is accumulated.

It is expected that during the life of a patent maturing from this application many relevant systems and methods will be developed and the scope of the term a water generation unit, a manager, a controller, and a water treatment unit is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1-19. (canceled)

20. A method of managing water supply, comprising:
accumulating water generated as a product of an operation a vehicle air conditioner of a vehicle;
detecting if a cooling capacity of said vehicle air conditioner being higher than a heat load of the passenger compartment of said vehicle; and
allocating a portion of said cooling capacity to increase the water generation of said vehicle air conditioner.

21-79. (canceled)

80. A drinking water production system comprising:
an air cooler operative to receive a variable flow of air and cool said flow of air and produce condensate water as a result of cooling said air;
a condensate water cleaner operative for removing contaminants from said condensate water, thereby producing cleaned water; and
a water production maximizing air flow controller governing the quantity of said flow of air to said air cooler, thereby maximizing production of condensate water thereby.

81. A drinking water production system according to claim 80 and also comprising an additive provider operative to add at least one additive to said cleaned water.

82. A drinking water production system according to claim 80 and wherein said water production maximizing air flow controller is responsive to at least one of temperature and humidity of said flow of air.

83. A drinking water production system according to claim 80 and wherein said air cooler forms part of an air conditioner.

84. A drinking water production system according to claim 80 and also comprising a pre-cooler for pre-cooling said flow of air to said air cooler.

85. A drinking water production system according to claim 80 and also comprising a water production requirement responsive controller for operating said air cooler even when air cooling is not required other than for water production.

86. A drinking water production system according to claim 80 and wherein said water production maximizing air flow controller is responsive to both temperature and humidity of said flow of air.

87. A drinking water production system according to claim 80 and wherein said air cooler forms part of a vehicle air conditioner.

88. A drinking water production system according to claim 80 and also comprising an available electric power utilizing controller governing the operation of said air cooler so as to maximize production of condensate water for the available electrical power.

89. A drinking water production system comprising:
an air cooler operative to receive a variable flow of air and cool said flow of air and produce condensate water as a result of cooling said air;
a condensate water cleaner operative for removing contaminants from said condensate water, thereby producing cleaned water; and
an available electric power utilizing controller governing the operation of said air cooler so as to maximize production of condensate water for the available electrical power.

90. A drinking water production system according to claim 89 and also comprising an additive provider operative to add at least one additive to said cleaned water.

91. A drinking water production system according to claim 89 and also comprising a water production maximizing air flow controller responsive to at least one of temperature and humidity of said flow of air.

92. A drinking water production system according to claim 91 and wherein said water production maximizing air flow controller is responsive to both temperature and humidity of said flow of air.

93. A drinking water production system according to claim 89 and wherein said air cooler forms part of an air conditioner.

94. A drinking water production system according to claim 89 and also comprising a pre-cooler for pre-cooling said flow of air to said air cooler.

95. A drinking water production system according to claim 89 and also comprising a water production requirement responsive controller for operating said air cooler even when air cooling is not required other than for water production.

96. A drinking water production system according to claim 89 and wherein said air cooler forms part of a vehicle air conditioner.

97. A vehicle mounted water production system comprising:
a vehicle air conditioner operative to receive a variable flow of air and cool said flow of air and produce condensate water as a result of cooling said air; and
a condensate water cleaner operative for removing contaminants from said condensate water, thereby producing cleaned water.

98. A vehicle mounted water production system according to claim 97 and also comprising a man machine interface (MMI) for allowing an operator to select among at least two operating modes of a group consisting of a cooling mode, a warming mode, a water generation mode, and a combined mode of cooling or warming and improved water generation.
